(19) United States
(12) Patent Application Publication
(10) Pub. No.: US 2026/0057533 A1
(43) Pub. Date: Feb. 26, 2026

(54) High Resolution Alignment of 3D Imaging with 2D Imaging

(71) Applicant: The Board of Trustees of the Leland Stanford Junior University, Stanford, CA (US)

(72) Inventors: Yonatan Winetraub, Los Gatos, CA (US); Komal Sharma, Palo Alto, CA (US); Aidan Van Vleck, Mountain View, CA (US); Emilie Manning, Belmont, CA (US); Kavita Yang Sarin, Los Gatos, CA (US); Diego Alejandro Godoy Ruge, Cupertino, CA (US); Zerlina Jilan Lai, Saratoga, CA (US)

(21) Appl. No.: 19/255,008

(22) Filed: Jun. 30, 2025

Related U.S. Application Data
(63) Continuation-in-part of application No. 17/601,368, now Pat. No. 12,361,656.
(60) Provisional application No. 62/832,093, filed on Apr. 10, 2019.
(60) Provisional application No. 63/665,719, filed on Jun. 28, 2024.

(51) Int. Cl. G06T 7/33; G06T 15/20; G06V 20/69

(52) U.S. Cl. CPC G06T 7/337; G06T 15/205; G06V 20/69; G06T 2207/30024; G06T 2210/41

(57) ABSTRACT

Alignment of a 2D image to a corresponding 3D image is provided by writing a pattern into a 3D sample. The pattern is at known positions in the 3D image, and provides visible reference features in the 2D image. This permits accurate determination of the plane in the 3D image that corresponds to the 2D image. Improvements in this work relate to: sample preparation, for example direct staining of the tissue with a dye that binds to the tissue; alignment accuracy, for example using patterns and optics that provide better depth information; and use of the 2D images to render a 3D image where the reference features from the pattern enable the 3D rendering.

### CROSS REFERENCE TO RELATED APPLICATIONS

This application claims priority from U.S. Provisional Patent Application 63/665,719 filed Jun. 28, 2024, which is incorporated herein by reference.

This application is a continuation-in-part of U.S. patent application Ser. No. 17/601,368 filed Oct. 4, 2021, which is incorporated herein by reference.

U.S. patent application Ser. No. 17/601,368 is a 371 of PCT Application PCT/US2020/027735 filed Apr. 10, 2020, which is incorporated herein by reference.

PCT Application PCT/US2020/027735 claim the benefit of Provisional Patent Application 62/832,093 filed Apr. 10, 2019, which is incorporated herein by reference.

### GOVERNMENT SPONSORSHIP

This invention was made with Government support under contract OD031858 awarded by the National Institutes of Health. The Government has certain rights in the invention.

### FIELD OF THE INVENTION

This invention relates to alignment of 3D imaging with corresponding 2D imaging, or to rendering a 3D image from several 2D images.

### BACKGROUND

Optical Coherence Tomography (OCT) is a non-invasive method to image tissue at cellular-level resolution. Many applications of cancer tumor detection or tumor margin classification using OCT images have been developed. However, in clinical practice, the gold standard against which these methods are compared is histo-pathological sections of the same area. One key problem that remains is how to find the same OCT image that corresponds to a given histo-pathology section at single-cell resolution. Accordingly, it would be an advance in the art to provide sufficiently accurate alignment of 2D images to corresponding 3D images.

### SUMMARY

Alignment of a 2D image to a corresponding 3D image is provided by writing a pattern into a 3D sample. The pattern is at known positions in the 3D image, and provides visible reference features in the 2D image. This permits accurate determination of the plane in the 3D image that corresponds to the 2D image.

For example, the tissue can be stained with fluorescent dye (or embedded in a gel stained with fluorescent dye), which can then be photobleached using the OCT laser or a separate laser. For example, OCT can be performed at 900 nm and bleaching done at 680 nm. After staining the tissue, the laser power is used to photobleach a specific pattern/barcode onto the tissue. The tissue is then sent to undergo normal histo-pathology sectioning. The resulting bar-code can be read off the pathology section allowing for the alignment of the histology section to the corresponding slice of the OCT volume with an unprecedented accuracy of less than 20 microns.

Accurate alignment of OCT and histology sections enables many applications that arise from having histological information alongside OCT structural and temporal information. One application is to use machine learning to directly predict histological images from a given OCT image, enabling non-invasive histology-like images. In one embodiment, the technique allows for the creation of a dataset of paired OCT and histology images necessary for such an application. A second application is to combine the structural and dynamic information that OCT allows for (non-invasive in-vivo longitudinal imaging), with metabolic/protein information from histo-chemistry. For example, one could image the activities of particular cells in a tumor over time in OCT, and then pair that information with molecular information from a histological section, which is from a single time point.

International patent application PCT/US2020/027735 filed on Apr. 10, 2020, and hereby incorporated by reference in its entirety, provides further details regarding the above-described approach. The present application considers several improvements to the approach of PCT/US2020/027735. These improvements can be practiced individually or in any feasible combination. Many of these improvements are motivated by the desire to create improved 3D atlases.

The problem of how to create a reliable 3D atlas from pathological slides is a competitive problem. 3D atlases are commonly used for biomarker discovery, basic science applications of understanding how tissue is organized in the microscopic structure as well as have applications in drug discovery and treatment mechanisms.

Today, 3D atlases can be composed from pathology slides by performing feature matching between the slides. This technique limits 3D atlases in a few ways. First, all slides are stained with the same single stain with minimal stain variability. If multiple stains are used, they need to be showing the same histological features which limits the variety of stains that can be used. Feature-based alignment is sensitive to the loss of any sections, as it breaks the 3D continuity, reducing accuracy and reliability. Section loss is unpredictable, and to some extent, unavoidable at a large scale. These constraints make it very difficult to provide rich datasets containing spatial-omics and multi-stains and compiling them to a uniform datasets.

The present work is an important step in bridging between spatial-omics and 3D atlases.

In order to relatively match the orientation, position and any deformations of 2D tissue sections one to another to create a 3D volume, we must account for micrometer-scale non-linear movements within the tissue. In order to do so in some embodiments, we dye the entire tissue with a fluorescent dye and photobleach specialized markers that allow us to reconstruct the relative position and micro-deformations of each slide to a standard reference. Two important aspects of this work are summarized as follows.

### 1. Introducing a Dye to Uniformly Stain the Tissue

Introducing dye to the tissue presents a conflicting set of requirements: dye needs to bind quickly and covalently to the tissue as well as not bind quickly in order to allow for sufficient time to diffuse before binding. Rapidly-acting functional groups bind to only a small part of the tissue, undesirably limiting where the pattern can be. Unbound or weakly bound dye won't be able to maintain the photobleached marks through processing, resulting in blur or complete deletion of the barcode. Simultaneously, to attain a uniform fluorescent background enabling efficient detection of barcode marks, the dye must also diffuse long enough to stain enough of the tissue before covalent binding. Standard dyes with rapidly acting functional groups like NHS-ester, TFP ester, maleimide or hydrazide provide high binding affinity but are able to dye skin only up to depths of 50 μm before the reaction completes. On the other hand, lipophilic dyes and small fluorescent tracers such as sulforhodamine are able to diffuse deeply to the tissue but display weak binding affinities and are thus unable to retain the photobleached marks. In order to resolve the conflict between rapid, permanent binding and slow dye diffusion, we explored three novel approaches described in depth below. Thus, in order to create uniformly fluorescent tissue that can carry photobleach marks through histological processing, dyes must react slowly enough to enable full diffusion through the tissue, before binding irreversibly

### 2. Photobleaching Alignment Markers

We use high-magnification lenses to focus a laser on the tissue, photobleaching fluorophores described in the previous section. This laser photobleaches long lines into the tissue to construct an engineered grid pattern in the tissue itself. The use of high-magnification lenses during photobleaching creates an “hourglass” shape in the cross-section of the photobleached line due to the natural focus shape of the lens. Both the overall grid and the hourglass shape of the focus contribute to the alignment algorithm in downstream histology sections. These hourglass patterns can then be further optimized to provide z-depth alignment capabilities.

### BRIEF DESCRIPTION OF THE DRAWINGS

FIG. 1 schematically shows writing a bar code pattern into a sample to facilitate alignment of 2D images with a corresponding 3D image.

FIG. 2 schematically shows an OCT setup suitable for use in connection with embodiments of the invention.

FIG. 3 shows examples of dye staining of brain tissue.

FIG. 4 shows an example of a problem that can arise in dye staining of skin.

FIG. 5 relates to injection of dye with micro-needles.

FIG. 6 is a general protocol for ex vivo co-registration.

FIG. 7 shows an example of coordinates for scanning and photobleaching of a GBM (glioblastoma multiforme) sample.

FIG. 8 shows several examples of photobleaching.

FIG. 9 shows an exemplary photobleaching pattern.

FIG. 10 shows photobleaching results for the pattern of FIG. 9.

FIG. 11 shows several preferred sample holders.

FIG. 12 shows veiling of reverse processed tissue.

FIG. 13 shows photobleaching on reverse processed veiled tissues.

FIG. 14 shows images of fluorescent paraffin with and without photobleaching.

FIG. 15 is a general protocol for in vivo co-registration.

FIG. 16 shows fluorescent images of veiled in vivo tissues and their corresponding sections.

FIG. 17 shows fluorescent images of photobleach markers on autofluorescence.

FIG. 18 is a comparison of 10× and 40× lenses for photobleaching.

FIG. 19 is an annotated example of cellular-resolution co-registration.

FIG. 20 is a demonstration of cellular-resolution co-registration across six sequential sections.

FIG. 21 shows the main concepts of the XY-pattern.

FIG. 22 shows an exemplary XY-pattern and accounting for deviations of the 2D images from planarity within the sample.

FIG. 23 shows some representative results for co-registration using an XY pattern.

FIG. 24 shows a template view of the presently preferred XY-pattern.

FIG. 25 shows results relating to another XY-pattern.

FIG. 26 is a qualitative comparison of different photobleaching exposure times and number of passes.

FIG. 27 shows how height changes in processing can introduce lateral distance error.

FIG. 28 schematically shows a Z-pattern.

FIG. 29 shows an example fluorescence image cross section of two Z-patterns.

FIG. 30 is an example showing co-registration error.

FIG. 31 shows fluorescent sections showing the effects of photobleaching at different Z-depths.

FIG. 32 is a demonstration of photobleaching fields of view, surface detection and Z-correction.

FIG. 33 shows an example of user validation of surface detection.

FIG. 34 is a visualization of barcode pattern depth encoding.

FIG. 35 shows exemplary round 1 results in a multi-round protocol.

FIG. 36 shows exemplary round 2 results in the multi-round protocol of FIG. 35.

FIG. 37 shows a 3D histological reconstruction from stacked sections.

FIG. 38 shows an example of variation in pattern placement across rounds.

### DETAILED DESCRIPTION

Section A briefly reviews some of the work of PCT/US2020/027735. Section B relates to improvements in sample preparation. Section C relates to improvements in accuracy. Section D relates to detection of the sample surface. Section E relates to iterative bleaching and sectioning of a sample. Section F relates to 3D rendering using 2D images.

### A) Introduction

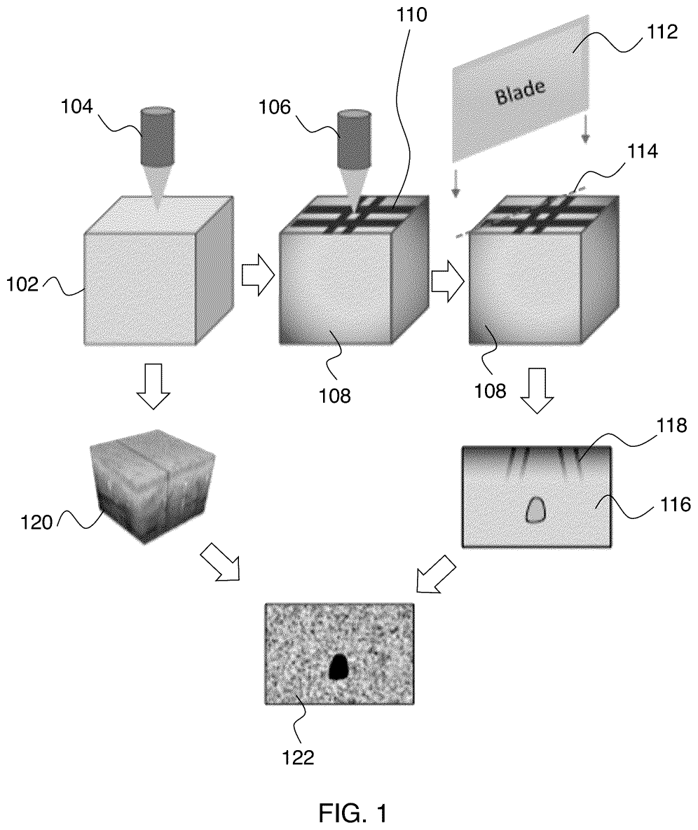

FIG. 1 shows an example of the work of PCT/US2020/027735. This method of aligning a 2D image to a corresponding 3D image includes the following steps:
providing a 3D sample 102;
writing a predetermined pattern 110 within the 3D sample 102 (e.g., with an optical beam 106). The result is a patterned sample 108;
cutting a 2D slice from the 3D sample after the predetermined pattern is present (e.g., by cutting with a blade along line 114);
imaging the 3D sample to provide a 3D image 120 with a first imaging modality (e.g., with an optical coherence tomography system schematically shown by 104). This 3D imaging can be done either before or after the predetermined pattern is written; since patterning can take a considerable amount of time (around 13 minutes total), imaging before patterning guarantees the tissue is in better condition and wasn't degraded much before being imaged. Doing the patterning first makes it easier for automation, as patterning may involve changing the optical configuration, therefore doing it first allows the operator to complete the task, and leave the room while the OCT scanner completes scanning the tissue which may take up to an hour.
imaging the 2D slice to provide a 2D image 116 with a second imaging modality, wherein the predetermined pattern provides reference features 118 in the 2D image; and
automatically determining a 2D section 122 of the 3D image that corresponds to the 2D image 116 using the reference features 118 in the 2D image 116.

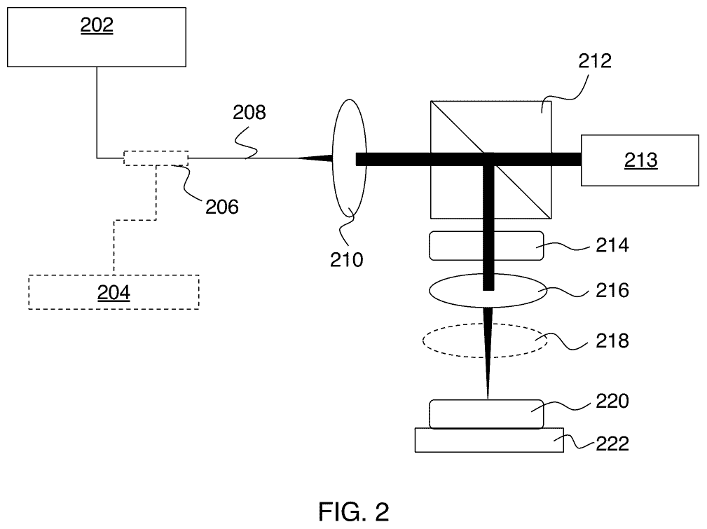

FIG. 2 shows an exemplary OCT system for use in connection with embodiments of the invention. Here 202 is a light source and spectrometer, 204 is an optional second light source and 206 is an optional fiber coupler for combining the outputs of sources 202 and 204. Coupler 506 can be used as wavelength combiner or optical switch in the forward direction (left to right) and as a wavelength splitter in the reverse direction (right to left). This ensures that high optical intensity as needed for photobleaching does not enter the OCT detector system within block 202 (which could be damaging to the detector). It also ensures that the OCT signal light is routed to block 202 for detection.

Fiber 208 carries light from source 202 to the rest of the system. Collimator 210 collimates light emitted from fiber 208. For simplicity, the reference arm needed for an OCT system is shown schematically as block 213. Beam splitter 212 splits light from collimator 210 so that some light goes to reference path 213 and some light goes to sample 220. Sample 220 is mounted on translation stage 222. Between beam splitter 212 and sample 220 is an optical train including a galvanometer 214 (for scanning the beam), an objective 216 and (optionally) a removable spectral filter 218. In operation, light from sample 220 and light from reference arm 213 is combined by beam splitter 212 to interfere in a detector included in source 202.

Galvanometer 214 provides 2D beam scanning, and it can be a combination of two orthogonal 1D scanners, or a single device that provides 2D scanning.

### B) Sample Preparation

### B1) Staining Tissue

### B1.1) Introduction

In order to create a tissue specimen capable of carrying and displaying fluorescent fiduciary lines from bulk ex-vivo or in-vivo tissue through histological processing and microtome sectioning, an even, homogenous fluorescent stain should be propagated through the entire bulk tissue specimen. Uneven fluorescent distribution, markings, or artifacts may introduce ambiguity in identification of the fiduciary markers, reducing the confidence and fidelity of their accuracy in co-registration with histological slides. While minor issues with “false” or missing fiduciary lines can often be compensated for by redundancies in photobleaching patterns, the need for uniform staining to enable cellular-resolution co-registration is important. However, complications with dye binding mechanisms as well as the different physical properties of various tissues require a nuanced protocol to create a uniformly stained fluorescent tissue capable of maintaining fiduciary markers permanently, especially through the histological processes.

This presents a conflicting set of requirements: dye needs to bind permanently to the tissue as well as not bind quickly in order to allow for sufficient time to diffuse before binding. Rapidly acting functional groups which irreversibly bind to the tissue, ensuring the retention of fluorescence and the photobleached barcode throughout histological processing and sectioning. Unbound or weakly bound dye won't be able to maintain the photobleached marks through processing, resulting in blur or complete deletion of the barcode. Simultaneously, to attain a uniform fluorescent background enabling efficient detection of barcode marks, the dye should also diffuse throughout the tissue before covalently binding. Standard dyes with rapidly acting functional groups like NHS-ester, TFP ester, maleimide or hydrazidel provide high binding affinity but are able to dye skin only up to depths of 50 μm before the reaction completes. On the other hand, lipophilic dyes and small fluorescent tracers such as sulforhodamine are able to diffuse deeply through the tissue but display weak binding affinities and are thus unable to retain the photobleached marks. In order to resolve the conflict between rapid, permanent binding and slow dye diffusion, we explored several novel approaches: Slow Acting Dye, Light Activatable Mediator, Dye Fixation with Formalin, as well as utilizing autofluorescence. We introduce these dyes by surface incubation, or micro-needle injections to improve uniformity. These approaches appear to be effective in tissue are able to bind and hold the photobleach pattern

### B1.2) Dye Binding Mechanisms

### B1.2.1) Autofluorescence

Most fresh tissues exhibit fluorescence due to the presence of intrinsic fluorophores within the tissue matrix. This autofluorescence signal intensifies on 10% Neutral Buffered Formalin (10% NBF) fixation as the process either generates new fluorophores or unveils the existing ones. This property has been utilized to create photobleached markers within the tissue without the need for external dye incubation. However, this approach has limitations as the fluorescence signal is relatively short-lived, and tends to diminish over time, reducing the long-term stability and visibility of the photobleached patterns.

### B1.2.2) Rapidly Binding Dyes

Dyes containing highly reactive functional groups, such as succinimidyl ester (SE or NHS-ester), tetrafluorophenyl ester (TFP-ester), maleimides, or hydrazides, bind quickly and covalently to biomolecules containing primary amines or thiol groups. These dyes ensure strong fixation and sustained retention of the fluorescent signal that can also withstand paraformaldehyde (PFA) fixation and prolonged exposure to different solvents during tissue processing. However, their fast reaction kinetics severely limit diffusion, typically restricting dye penetration to superficial layers of the tissues like skin (≤50 μm) and brain (≤80 μm). As a result, the fluorescent background is often uneven, and photobleached marks at different depths are not maintained during processing. In our initial experiments, brain/skin tissue samples were incubated with Alexa Fluor 680 NHS-ester, a reactive amine-targeting dye that covalently binds to primary amine (—NH₂) groups of proteins and other amine-containing biomolecules. However, the fluorescence signal was predominantly localized to the outermost layers of the tissues. The NHS-ester is highly prone to rapid hydrolysis, inactivating the binding groups of the dye additionally contributing to reduced covalent binding and superficial signal. To assess whether hydrolysis was a limiting factor we utilized AZ dye 680 TFP ester, an amine-reactive fluorophore that incorporates hydrolytically stable TFP-ester group. Despite this modification, the fluorescence remained confined to the tissue surface (FIG. 1a). Subsequently, we explored an alternative conjugation mechanism with Alexa Fluor 647 hydrazide dye which targets aldehyde or ketone groups in polysaccharides and glycoproteins through its hydrazide functionality. This approach also resulted in surface-localized fluorescence, indicating minimal penetration into deeper tissue layers.

### B1.2.3) Fast Penetrating Dyes

In contrast to covalently reactive dyes, small fluorescent molecules such as sulforhodamine demonstrate significantly greater tissue penetration and more uniform distribution due to their small size and neutral or hydrophobic nature. However, these dyes often exhibit weak or reversible interactions with the tissues. As a result, they are easily washed out or degraded during photobleaching, fixation or processing, leading to loss or blurring of photobleached marks and failure of the barcode retention strategy. We shifted towards non-reactive dyes and tried sulforhodamine B for fluorescent veiling. Although the fluorescence intensity and uniformity was commendable in the brain, the photobleached lines faded over a period of time.

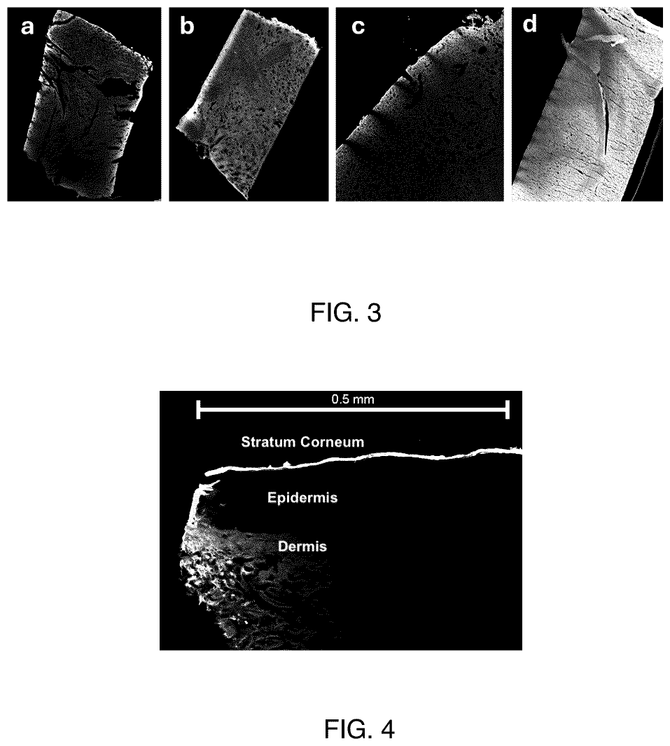

To resolve the fundamental conflict between rapid, irreversible covalent binding and the inherently slow diffusion of fluorescent probes through the tissues, we utilized three distinct labeling strategies (FIG. 3).

FIG. 3 shows veiled images of brain section obtained by sectioning perpendicular to the fluorescent surface after incubating the tissue with (a) AZ 680 dye TFP ester, (b) photoactivatable AZ dye 680 amine-ATFB-SE complex, (c) AZ TFP ester-Pentalysine complex, and (d) AZ dye 680 amine.

These approaches were designed to separate the diffusion and binding phases, allowing dyes to permeate deeply into tissues before initiating covalent binding. The three strategies include:

### 1. Photoactivatable Mediator-Dye Complex

This method employs an inert, diffusible mediator-dye complex that becomes reactive only after exposure to specific wavelengths of light, enabling precise control over the dye binding process. We conjugated AZ dye 680 amine with a photoreactive crosslinker, 4-Azido-2,3,5,6-tetrafluorobenzoic acid succinimidyl ester (ATFB-SE). The quick acting NHS-ester group of the mediator binds to the free primary amine of the dye leading to a chemically inert fluorescent dye-mediator complex. This complex passively penetrates throughout the tissue. Once fully diffused, it is allowed to react with the surrounding tissue by exposing the surface of the tissue with 405 nm light. Photoactivation of the complex triggers photolysis of the azide group on the mediator, generating a highly reactive nitrene intermediate. The nitrene reacts with nearby C—H bonds through a —CH insertion reaction, forming covalent linkages between the dye complex and endogenous tissue structures. Importantly, the 405 nm wavelength offers better tissue penetration (around >100 μm) than the fast acting dyes, enabling effective veiling ((b) on FIG. 3). Although this technique is highly efficient and reliable in generating permanent veiling for photobleaching, depths beyond 100 μm were still insufficient for reliably visualizing photobleach marks. Therefore, we explored an alternative approach that is not limited by light penetration.

### 2. Post-Diffusion Dye Binding Via Formalin Cross Linkage

This approach leverages paraformaldehyde (PFA) mediated binding, enabling deeper and more uniform penetration throughout the tissue. A rapidly acting fluorescent dye is linked with an inert mediator and the complex is allowed to passively diffuse deep in the tissue and fixed by introducing PFA after a specific interval of time. PFA creates covalent cross linkages between the dye-mediator complex and the biomolecules present in the tissues. Alexa Fluor 680 NHS ester or AZ 680 TFP ester is conjugated with amine groups of pentalysine, owing to the rapidly acting nature of the dye, it quickly binds to pentalysine and creates an inert complex that moves freely in the tissue. The stoichiometry is maintained such that for each molecule of pentalysine there are only two molecules of dye. Once the tissue is saturated with dye-pentalysine complexes, it is treated with PFA which fixes the complex by creating cross-linkages through methylene bridge between the amine groups present in the tissue and on the pentalysine backbone via a chain reaction leading to protein-CH-protein complexes. The dye-pentalysine complex is covalently incorporated into a tissue matrix producing a uniformly veiled tissue. Unlike the previous method where the veiling depth was restricted by shallow penetration of 405 nm light in the tissue, this strategy relies on the chemical fixation of the dye-pentalysine conjugate to achieve permanent veiling. However, owing to the large size of the conjugate the diffusion deep down the tissue is highly restricted. As a result, the surface appears uniformly veiled but effective photobleaching on the deeper parts of the tissue remains a challenge ((c) on FIG. 3).

### 3. Slow Acting Dyes

In all the previously explored methods, we encountered a common limitation that fluorescence was largely confined to the surface, while deeper tissue layers exhibited poor signal. All these strategies produced a well-veiled surface but they failed to achieve uniform fluorescence throughout the tissue depth. Therefore, in an attempt to generate a veiled tissue where the fluorescence is uniformly distributed to the deeper layers as well, we tried using a slow but covalently reacting dye. The amine functional groups present in AZ dye 680 amine covalently bind to the carbonyl groups present in proteins, glycoproteins, and extracellular matrix components of the tissue at a slow rate. This kinetic delay permits the dye to diffuse through the tissue matrix over extended incubation periods (1-2 days) prior to forming covalent bonds. The extended reaction time facilitates a more uniform dye distribution within the tissue, allowing for effective photobleaching of barcode patterns that remain intact through fixation, embedding, and sectioning. This approach yields a homogenous fluorescent background throughout the tissue while preserving barcode fidelity ((d) on FIG. 3).

### B1.3) Tissue Mechanics and Physical Barriers to Dye Penetration

The physical properties of different tissues complicate efforts to achieve uniform fluorescent staining. Tissues such as skin and brain respond differently to incubation in dye solutions, requiring tailored protocols for effective staining.

In skin, the outermost layer, the stratum corneum, forms a hydrophobic barrier that significantly impedes the diffusion of aqueous solutions. This presents a major challenge, as many fluorescent dyes are water soluble. When bulk skin tissue is incubated in dye, fluorescence uptake varies across layers.

The dermis, a loose net-like connective tissue beneath the epidermis, readily absorbs dye due to its porous structure. In contrast, the epidermis is densely cellular, with both its external side shielded by the stratum corneum and its internal side adjacent to the dermis. As a result, dye penetration into the epidermis is limited: It must either diffuse through the millimeter-thick dermis, cross the hydrophobic outer barrier or enter through the small exposed regions along the tissue's periphery.

FIG. 4 shows a Fluorescent histology section of skin tissue incubated in TFP Ester dye. Binding at the stratum corneum is clearly visible, diffusion into the dermis is more limited and virtually no dye has stained the Epidermis.

Alternative methods of bypassing the physical barriers in skin tissue have also been explored, principally by chemical or physical penetration. Microneedles were used to penetrate the epidermal layer of the skin. Hollow microneedle arrays were soaked in dye to allow uptake, before puncturing the skin tissue.

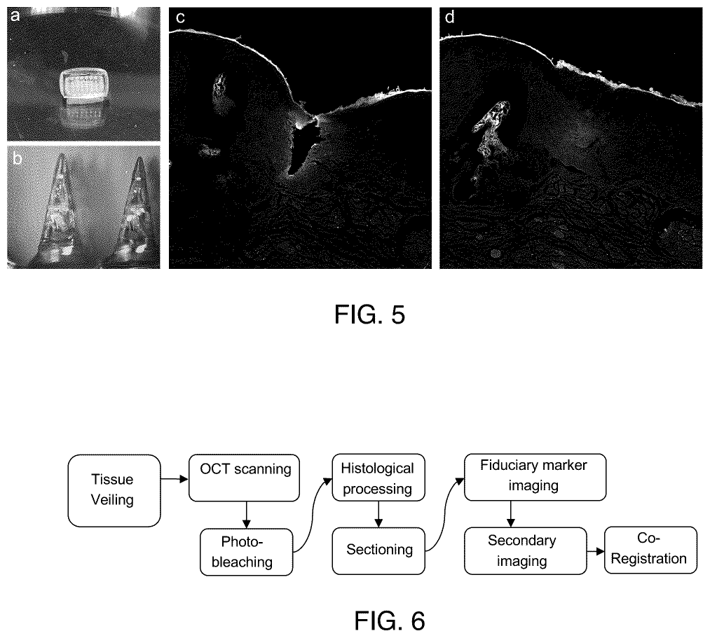

FIG. 5 shows introduction of dye via micro-needle injections a) a microneedle array passively injecting dye into the surface of tissue b) hollow microneedles c) A histology section containing microneedle puncture, displaying the Alexa Fluor 680 NHS Ester dye diffusion from the injection site d) A histology section 40 μm from the section in panel (c), showing the diffusion of dye away from the injection site.

Additional experiments involving chemical disruption of the Stratum Corneum were performed by topical application of Dimethyl Sulfoxide (DMSO) before immersion in fluorescent dye.

FIG. 6 is a generalized overview of the current protocol in all tissues. Different tissues require specialized nuance and techniques, but generally follow the same broad order of operations.

### B1.4) Tissue Veiling—Brain

Veiling refers to the process of inducing a uniform, intense, and irreversible fluorescence background across an entire tissue by incubating it with a fluorescent dye. The preparation of uniformly veiled tissue is an important step in the entire experimental workflow, as it directly influences the accuracy and efficiency of subsequent steps. A consistent and homogeneous fluorescence background throughout the tissue enhances the visualization and identification of fine details within the photobleached pattern/s, thereby enabling precise co-registration that would otherwise be challenging.

Veiling process includes the following steps: 1) Dye preparation 2) Sample preparation 3) incubation 4) washing. During sample preparation, the cerebrum is sectioned into uniformly flat slices of 1-2 mm thickness. Ensuring flatness is crucial, as it minimizes photobleaching errors like angled or distorted patterns which later interferes with the coregistration process. Dye incubation time significantly influences the sharpness of the photobleach marks. Although the tissue exhibits intense fluorescence as early as 30 min-2 hours, the most well-defined and crisp patterns are typically observed after 20 to 48 hours of incubation.

### B1.4.1) OCT Scanning

Once the tissue is veiled, it is prepared for scanning a 3D volume using Optical Coherence Tomography followed by photobleaching the exact same spot. See section B2 for details regarding preferred sample holders for flattening the sample.

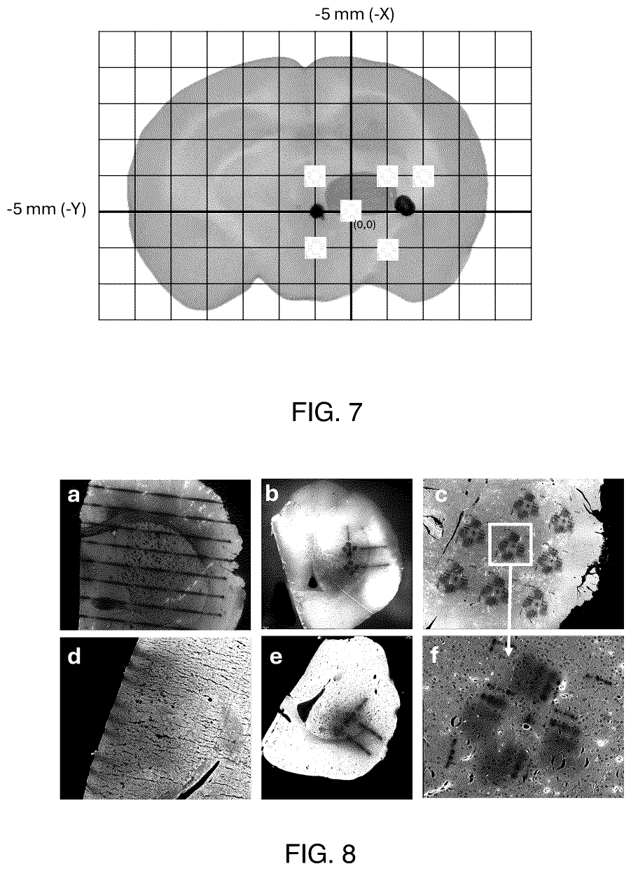

FIG. 7 shows exemplary coordinates for scanning and photobleaching of a GBM (glioblastoma multiforme) sample.

### B1.4.2) Photobleaching and Sectioning

FIG. 8 shows several examples of photobleaching: a) long lines in bulk tissue; b) xy-pattern in bulk tissue; c) section of multiple rounds of xy-patterns d) perpendicular cryosection of bulk tissue (a) with long lines; e) same plane cryosection of bulk tissue (b) with xy-pattern; f) FFPE section with xy-pattern.

Initial photobleaching experiments involved marking the tissue with multiple long lines at different depths ((a) on FIG. 8) followed by sectioning perpendicular to the photobleached pattern, producing a visible hourglass-shaped mark along the section edge. The XY-pattern ((b) and (c) on FIG. 8) was developed which allows sectioning in the same plane as the pattern is drawn.

The tissues can be sectioned either using a microtome or a cryotome. The distinction in the images obtained from these is shown in FIG. 8.

### B1.5) Tissue Veiling—Skin

Generation of uniformly fluorescent skin tissue is broken into three main component steps: 1) tissue preparation and flattening 2) fluorescent incubation and fixation and 3) tissue washing and long-term storage. Following tissue veiling, the tissues are prepared for imaging.

### B1.6) Skin Results

Fiduciary photobleaching marks can be consistently photobleached into tissues, and appear clearly in histological fluorescent section images.

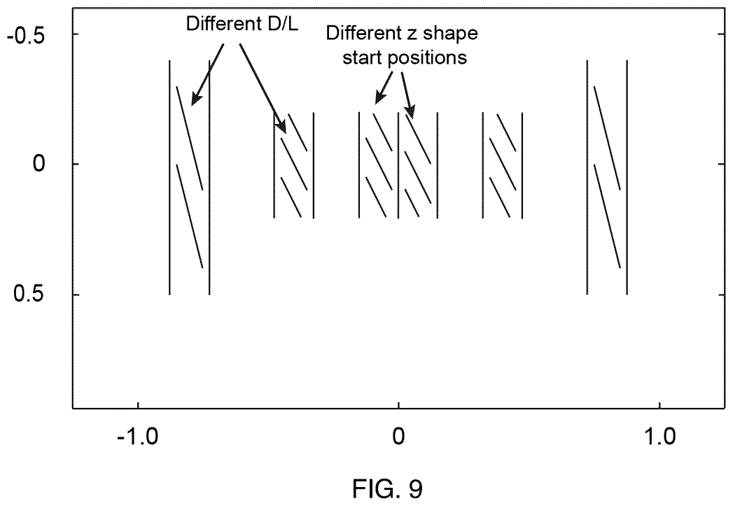

FIG. 9 shows an exemplary photobleaching pattern.

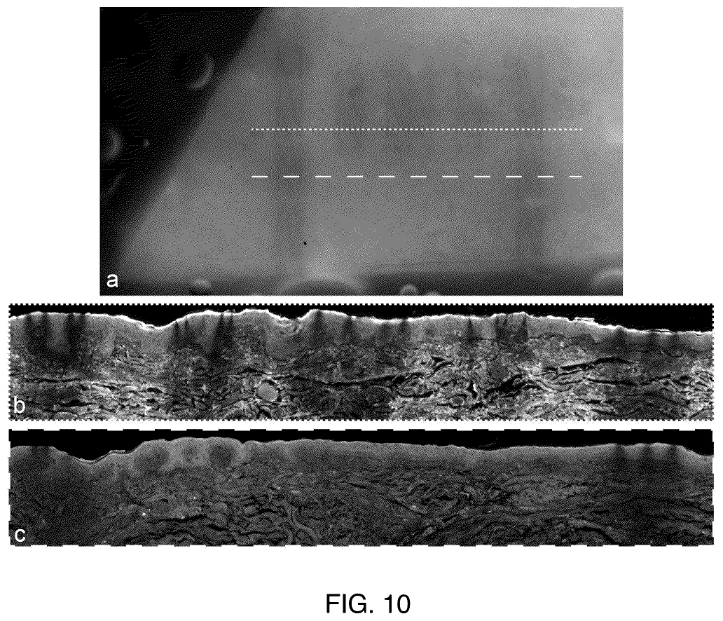

FIG. 10 shows corresponding results: Here panel (a) is the generated overview grid, detailing the XY coordinates of the fiduciary markers relative to the OCT. Panel (b) is a fluorescent image of a histological section collected from this sample. Its position in the tissue's XY plane is denoted with a dotted line in part (a) of FIG. 10. Clearly visible within the epidermis is the characteristic hourglass shape of the 40× fiduciary markers. Panel (c) is another fluorescent image of a histological section collected from this sample. Its position in the tissue's XY plane is denoted with a dashed line in part (a) of FIG. 10.

### B2) Sample Holder for Flattening the Sample

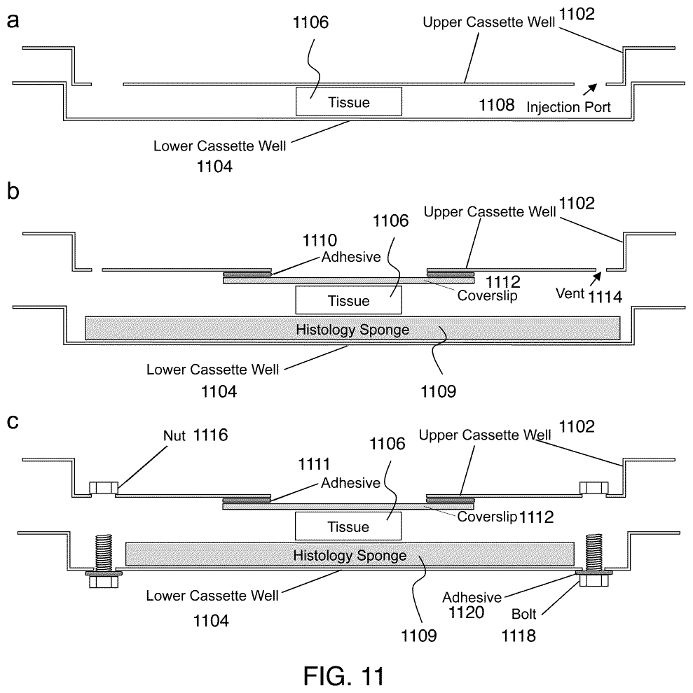

As indicated above, it is often preferred to use a specialty sample holder for flattening the sample. FIG. 11 shows three exemplary configurations for such a sample holder.

Panel (a) of FIG. 11 shows an Upper Fixation Compression Cassette. Its general purpose is for maintaining tissue flatness and orientation during fixation (preservation). It is not used for imaging-thus, it has no imaging window. Large injection ports 1108 are used to inject a gel that creates a “mold” around the tissue 1106, holding it in place during fixation. This sample holder relies on compressive force between the upper and lower cassettes 1102 and 1104 respectively. No histology sponge is used, as this disrupts the strength of the gel mold.

Panel (b) of FIG. 11 shows an Upper Imaging Compression Cassette. Its general purpose is to flatten and gently compress tissue during imaging. It includes an imaging window 1112, installed with a silicone adhesive 1110. Small holes 1114 provide venting for excess gel to be expelled during compression. It relies on compressive force between the upper and lower cassettes. It also includes a histology sponge 1109 soaked in 10% Gelatin solution under the tissue.

This does several things:
1) Create an upwards “spring” force that absorbs most of the compressive force applied by the upper cassette. This protects the tissue from being crushed, while still enabling compression/flattening of the surface for imaging.
2) Gelatin gel keeps the tissue hydrated/prevents desiccation when tissue is compressed for any length of time.
3) Gelatin gel is sticky, and thus helps maintain tissue position well even if the cassette is moved, bumped, dropped, etc.

Panel (c) of FIG. 11 shows a brain imaging compression cassette. Its general purpose is for imaging of the brain or other delicate tissues, and for long-term imaging. It provides variable and precise control of compression (with the screws 1118) for sensitive tissue types. Here imaging window 1112 can be installed with UV-curing resin 1111. This configuration has a watertight tissue compartment, which allows incubation in solutions over time without leakage—this allows longitudinal time studies on the effect of solution on tissue. This is particularly important because while imaging with a high magnification lens, lens immersion fluid (e.g. Water, silicone oil, etc.) must be placed within the upper cassette well. If this solution leaks into the tissue chamber, or solution leaks out of the tissue chamber, the tissue may dry out or the solution may be diluted. This also means there are no vents.

A histology sponge 1109 is again used, but not always soaked with gelatin. It can be soaked in various other solutions (ethanol) that are better suited for delicate tissues (like brain) or as experimentally demanded. Ethanol can be used here because the chamber is watertight and will not evaporate.

### B3) Staining Tissue in a Paraffin Block

### B3.1) Introduction

For rare or complex conditions, the acquisition of freshly excised tissue samples is often challenging due to low frequency of cases, limited patient accessibility and strict regulatory constraints. Additionally, the difficulty in preservation of tissue integrity due to its sensitive nature and potential delays in processing further limit the availability of high-quality fresh samples. In such cases, archived specimens preserved in the form of formalin-fixed paraffin embedded (FFPE) serve as a valuable resource. Formalin preserves the molecular integrity and cellular morphology of the tissue by crosslinking proteins. Further, paraffin embedding provides mechanical stability to the tissue and protects its structural morphology.

However, the presence of paraffin in FFPE tissues hinders the OCT imaging and photobleaching. Owing to its hydrophobic nature, paraffin restricts the penetration of water-soluble fluorescent dyes inside the tissue. Additionally, it interferes with the OCT imaging and photobleaching due to significant light scattering. Therefore, to address these limitations, a customized protocol involving paraffin removal and veiling, is developed.

The design of the reverse processing protocol requires careful optimization of solvent type and exposure time. Sudden changes in solvent polarity can lead to osmotic stress, tissue shrinkage, or distortion, which can negatively impact both imaging quality and molecular labeling. Hence, a gradual transition and controlled solvent exchange ensures gentle removal of paraffin. The goal of reverse processing is to recover the tissue to a functional state that mimics freshly fixed samples in both morphology and molecular information.

### B3.2) Reverse Processing

Reverse tissue processing ensures elimination of residual paraffin and restoring tissue permeability. It includes two steps i.e. deparaffinization and rehydration.

### B3.2.1) Deparaffinization

The process begins with the removal of tissue from the paraffin block, followed by deparaffinization to eliminate the hydrophobic wax. Since paraffin is incompatible with aqueous reagents, it is dissolved using non-polar organic solvents such as xylene or Citrisolv. These solvents interact with paraffin via Van der Waals forces, effectively dissolving and extracting it from the tissue matrix.

Skin tissue, with its relatively hydrophilic extracellular matrix responded well to standard deparaffinization procedures. In contrast, brain tissue is predominantly lipophilic in nature due to high lipid and myelin content. Therefore, standard solvent exposure times were insufficient to fully remove embedded paraffin. This incomplete deparaffinization resulted in stiff tissue and reduced permeability compared to freshly fixed brain tissue. To overcome this, the protocol for brain samples required extended xylene exposure combined with gentle agitation to facilitate thorough paraffin extraction and restore the tissue's original pliability and dye-absorbing capacity.

### B3.2.2) Rehydration

Following deparaffinization, the tissue undergoes a rehydration process to restore its native environment, which is important for increasing the tissue compatibility with hydrophilic dyes required for veiling. Rehydration is achieved by sequentially immersing the tissue in a series of ethanol solutions with decreasing concentrations-100%, 100%, 100%, 95%, 80% and 70%. Use of ethanol facilitates a smooth and controlled transition between non-polar xylene and polar aqueous solution of dye thereby minimizing osmotic stress and preventing morphological distortion. Multiple immersions in 100% ethanol are used because the jars for the earlier immersions in ethanol tend to become contaminated by xylene as the process is repeated.

### B3.3) Results

### B3.3.1) Veiling

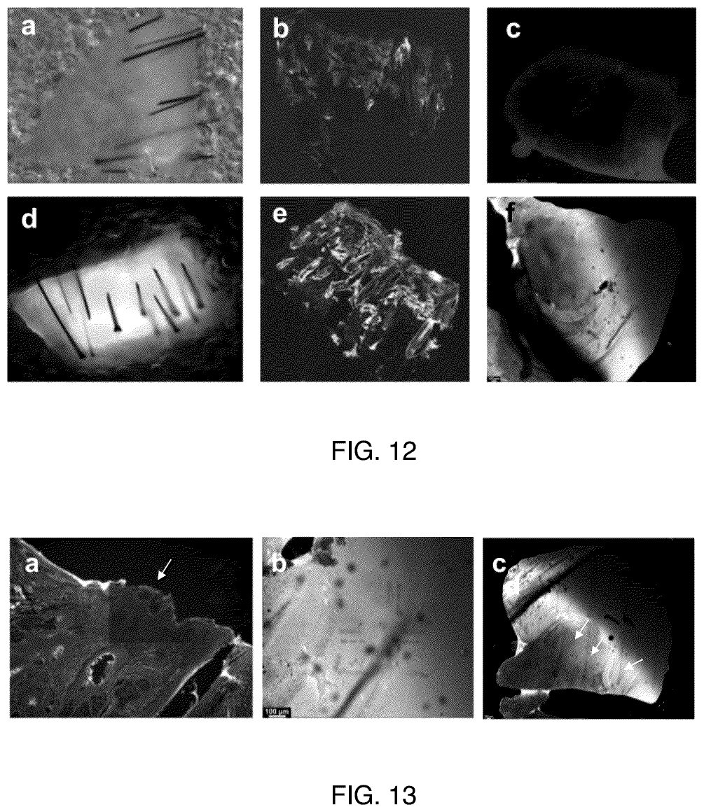

FIG. 12 shows veiling of reverse processed tissue, including images of negative controls of a) bulk skin; b) skin section; c) bulk brain (digitally enhanced for visibility); and including images obtained after veiling showing high fluorescence signal in d) bulk skin e) skin section and f) bulk brain.

Veiling is done by incubating the sample with a fluorescent dye that saturates the tissue and generates stable, irreversible bonds between the tissue and dye molecules (FIG. 12).
Tissue incubation: The reverse processed tissue is incubated in 1 mL of 6 μM solution of AZ 680 amine for 2 hours to 4 days in the incubator at 37° C.
Washing: Both brain and skin tissue are washed in 70% ethanol overnight for 18-24 h to ensure complete removal of the unbound dye.
Imaging: Fluorescence imaging of bulk tissue is carried out on fluorescence microscope (FIG. 12).

### B3.3.2) Photobleaching

FIG. 13 shows photobleaching on reverse processed veiled tissues, images shown are photobleached a) square on skin; b) xy-pattern on brain; c) long lines on brain
Tissue embedding: The tissue is embedded in a custom-designed imaging compression cassette. The veiled tissue is placed in the lower cassette on a sponge, the upper cassette is then carefully lowered and angled slightly to prevent the trapping air bubbles between the tissue surface and the imaging window.
Photobleaching: XZ-pattern is photobleached on the skin (FIG. 13, panel (a)) whereas XY-pattern (FIG. 13, panel (b)) and long lines (FIG. 13 panel (c)) are photobleached on the brain tissue.
Procedure: The tissue is placed on the OCT stage and levelled using pitch/roll/yaw stage. The focus is set at the tissue-coverslip interface at the center of the tissue. Initial photobleaching on skin is done on a keyence microscope by focusing the 100% intense laser beam to an area using a 40× lens. This photobleaches a square on the tissue (FIG. 13, panel (a)).

### B4) Staining the Paraffin Block

In an attempt to simplify the generation of photobleaching patterns, an alternative strategy was explored by developing fluorescent paraffin as an embedding medium. In this approach, once the tissue is embedded, photobleaching can be carried out directly on the fluorescent paraffin block rather than on the tissue itself. This eliminates the need for individual dye optimization protocols for each tissue type. This might help to reduce variability, simplify sample preparation, and provide a stable, uniform fluorescent background for photobleaching.

### Paraffin Veiling

### 1. Surfactant and Hydrophilic Dye

To dissolve hydrophilic dye, AZ Dye 680 amine in hydrophobic solvents, a surfactant, Span 85 (sorbitan trioleate), is used).

Procedure: 100 μL of dye is mixed with varying volumes i.e. 10-100 μL of Span 85. The mixture is then dropwise added to constantly stirring hot paraffin on a heating block and stirred for 10 min to 2 hours. Histology block is prepared, sectioned and imaged.

### 2. Optimizing Solvents

The dye is dissolved in solvents like acetone and ethyl acetate to enhance the solubility. This method had some negative effects on the structural integrity of the paraffin. Examples considered include:
a) AZ Dye 680 amine dissolved in acetone then dropwise added to paraffin
b) AZ Dye 680 amine dissolved in ethyl acetate then dropwise added to paraffin
b) Lipophilic dye
   Due to high solubility, lipophilic dye 1,1′-dioctadecyl-3,3,3′,3′-tetramethylindodicarbo cyanine, 4-chlorobenzenesulfonate salt (DiD) is directly added to the paraffin and analyzed.

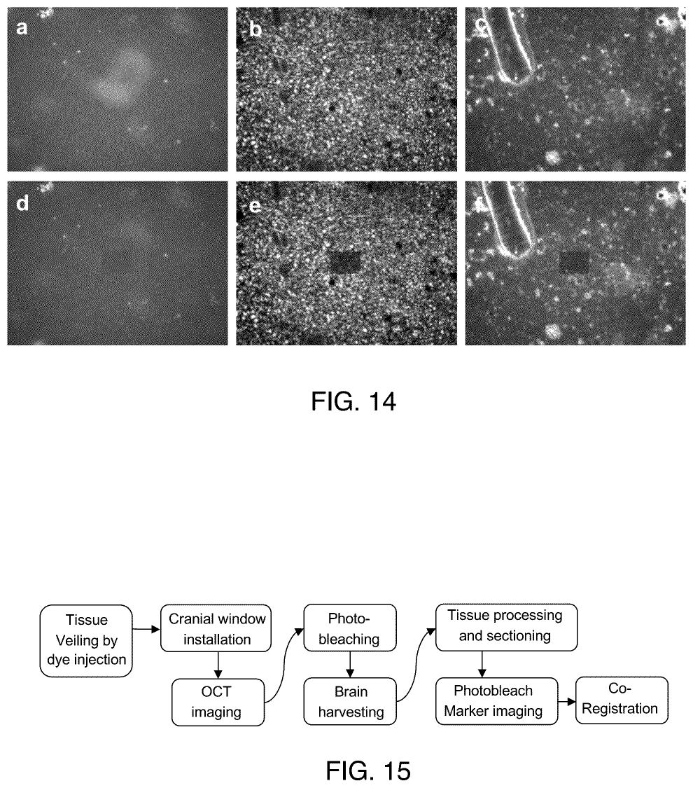

FIG. 14 shows images of fluorescent paraffin obtained by incubation of paraffin with a) dye and surfactant; b) 4 μM of DiD; and c) 6 UM of DiD and (d-f) their corresponding photobleached (a square) images.

### B5) In Vivo Staining

### B5.1) Introduction

This work aims to intricately study the cellular level changes in the activity and distribution of neurons, altered brain microenvironment and variations in blood flow and the related parameters in the diseased and healthy mice at high resolution using OCT imaging. The approach involves veiling the brain tissue in vivo and obtaining a high resolution 3D OCT scan through the cranial window followed by photobleaching at the same spot. The patterned tissue is then used for co-registration to obtain cellular and molecular level information on the scanned area.

Various dyes are evaluated individually to optimize both the staining protocol and the route of administration. It is essential to use dyes that form covalent bonds with cellular or extracellular components, ensuring that the signal remains stable despite the dynamic physiological environment of a live animal. Additionally, the dyes must retain their fluorescence through subsequent fixation and tissue processing steps following brain extraction. Based on these criteria, several dyes with distinct binding chemistries including Sulforhodamine B, AZ dye 680 TFP ester, Alexa Fluor 680 NHS ester, Alexa Fluor 647 hydrazide, DiI stain and combination of the dyes with mediators like pentalysine and N-Succinimidyl 4-Azidotetrafluoro benzoate (ATFB-SE) were selected for testing. FIG. 15 shows a generalized overview of this in vivo protocol.

### B5.2) Tissue Veiling

In vivo veiled tissue is generated by direct dye injection in mice involving administering a fluorescent dye systemically or locally to achieve consistent and widespread labeling of target tissues. Systemic administration routes such as tail vein injection, retro-orbital injection, or intraperitoneal injection are commonly employed to introduce the dye into the bloodstream which eventually reaches the brain. Alternatively, local delivery methods such as stereotaxic (intracerebral) injection or cortical surface application are used to target specific brain regions with high precision.

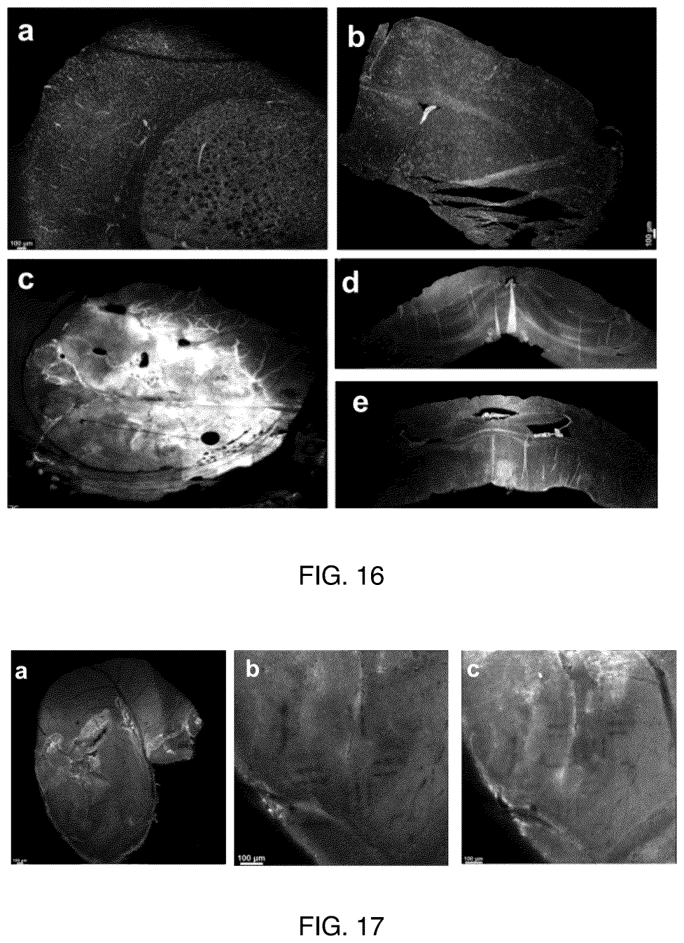

FIG. 16 shows fluorescent images of veiled in vivo tissues and their corresponding sections obtained by injecting dye in mouse via Tail vein injection (a) bulk tissue and (b) section; Intraperitoneal injection (c) bulk tissue and (d), (e) sections.

### B5.2.1) Tail Vein Injection

Tail vein injection involves administering a compound into one of the two prominent lateral veins located along the tail of the mouse. This method offers a minimally invasive and efficient route for systemic compound administration. Since the dye is injected directly into the venous circulation, it rapidly disperses via the bloodstream to various organs, including the brain (panels (a)-(b) of FIG. 16).

### B5.2.2) Intraperitoneal Injection

Intraperitoneal (IP) injection is a common method of administering compounds in mice by injecting directly into the peritoneal cavity. Once injected into the peritoneal cavity, the substance is slowly absorbed through the rich vascular network of the peritoneal lining and gradually enters systemic circulation (panels (c)-(e) of FIG. 16).

### B5.2.3) Cortical Application

Cortical application is a localized method of administering compounds directly onto the exposed surface of the brain cortex. This technique is typically performed following a craniotomy. It allows for precise spatial targeting of the compound to a specific cortical region without the need for systemic circulation. During cortical application, the dye is gently applied as a drop on the cortical surface which then diffuses into the superficial layers of the brain, allowing for controlled and localized labeling.

### B5.2.4) Direct Brain Injection

Direct brain injection, also known as intracerebral or stereotaxic injection, is a precise and targeted method for delivering dyes directly into specific brain regions. In this protocol, the injection is done through the cranial window using stereotaxic coordinates

The coordinates are given as three-dimensional (x, y, and z) distances in mm from bregma, which is the intersection of the coronal and sagittal sutures on the surface of the skull, with x representing the medial-to-lateral plane, y representing the rostral-to-caudal plane, and z representing the dorsal-to-ventral plane. To obtain targeting coordinates for a specific injection region, subtract the atlas coordinates from the position of the animal's bregma in the stereotaxic apparatus.

### B5.2.5) Imaging and Photobleaching Autofluorescence

Most fresh tissues exhibit fluorescence due to the presence of intrinsic fluorophores within the tissue matrix. This property has been utilized to create photobleached markers within the tissue without the need for external dye incubation. After installation of cranial window, the brain is imaged and photobleached using xy-pattern. FIG. 17 shows fluorescent images of photobleach markers on autofluorescence from (a) Bulk tissue; (b) and (c) sections.

C) Improved accuracy

### C1) Overview

Co-registration between non-invasive 3D volumes collected in ex-vivo tissue and downstream histological sections relies on highly-accurate fiduciary markers that encode information on the location of the three-dimensional volume with respect to the two-dimensional histology section. Previous iterations of this technology relied on the fiduciary markers being photobleached into a fluorescent gel overlying the tissue. This gel was designed to persist through histological processing, shrinking, morphing or otherwise deforming in tandem with the tissue. This technique reliably predicted co-registration coordinates within 60 microns of the co-registration plane. However, cellular-level co-registration required two major improvements: 1) Using a high-power 40× magnification lens during OCT image capture to generate cellular-resolution OCT images and 2) Photobleaching the fiduciary markers inside the tissue itself to improve marker fidelity.

The end goal of cellular-resolution co-registration is enabled by the development and implementation of multiple improvements to the protocol, many of which are detailed in other sections: Tissue and Tissue Preparation (Section B) and the Surface detection algorithm (Section D).

Here, we describe some further protocol adjustments enabling cellular-resolution co-registration. Then, we will discuss how all the component pieces work together in presently preferred embodiments to generate incredibly accurate fiduciary lines capable of enabling cellular-resolution co-registration. Finally, we will demonstrate validation methods employed to confirm the co-registered image pairs are correctly matched.

The several improvements discussed here are as follows:
1. Improved precision in inputs used to reconstruct the 3D OCT volume to enable cellular-resolution OCT.
2. Improvements to the methodology behind controlling the photobleaching laser, resulting in more accurate and legible fiduciary marks
3. Compensating for the adjustment in photobleaching marker structure when moving from 10× to 40×.

### C1.1) Photobleaching Laser Control

The optical setup in previous iterations of this protocol used a simple optical fiber splicer to connect the photobleaching laser to the optical path of the OCT. However, input delay significantly increased the duration of photobleaching from what was requested or expected.

In order to draw fine fiduciary photobleaching marks, finer control of the exposure time is needed. We integrated an optical switch into the setup, connecting the photobleaching laser to the OCT. This switch has significantly faster response time to control inputs—the laser itself does not turn off, but its light is not directed at the sample when the optical switch is in the OCT channel configuration. As a result, the exposure time and thus, photobleaching marks can be significantly more precise.

### C1.2) Photobleached Fiduciary Marker Shape: 10× vs 40×

In order to enable the highest degree of precision, the fiduciary markers photobleached into the tissue utilize the same optical path as the Optical Coherence Tomography scan. This is beneficial in several ways:
1. A lens is needed to focus the photobleaching laser to generate microscopic fiduciary lines
2. Fewer moving parts ensures that there is less chance for any mechanical miscalibration, or inaccuracy between the collection of the Optical Coherence Tomography scan and the photobleaching of the fiduciary markers

However, utilizing a common path for Optical Coherence Tomography imaging and photobleaching necessarily introduces a challenge—the shape of the photobleached mark depends on the lens it was focused through. The long depth of field in a 10× lens creates long, extended photobleaching lines. Contrastingly, a 40× lens generates a short hourglass shaped photobleaching mark.

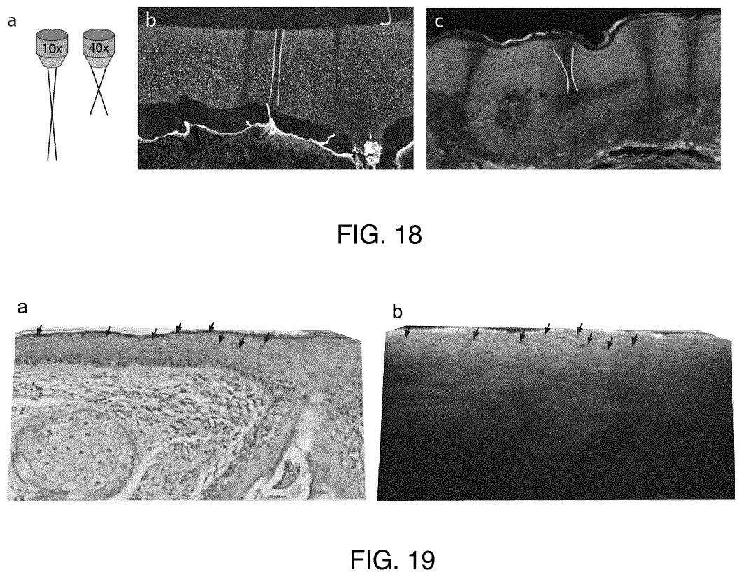

FIG. 18 shows a comparison of the depth of field in a low vs high magnification lens in panel (a), an example of the line-shaped photobleach marks when utilizing a 10× lens in panel (b), and the hourglass-shaped photobleach marks when using a 40× lens in panel (c). One way to quantify the hourglass shape is in terms of the Rayleigh range z_{R}, which is the distance along the propagation distance of a beam from its waist to a point where its cross section area is doubled (relative to the waist). For a Gaussian laser beam at wavelength λ having beam waist W, z_{R}=pi w\hat{ }2/λ. As the beam is more tightly focused (w decreases) its depth of focus (i.e., z_{R}) also decreases. In preferred embodiments we have z_{R} is no more than 10w, and more preferably z_{R} is no more than 6w.

Photobleaching in a gel with the 10× lens was relatively simple—the gel always created a perfectly flat surface, and the long, extended nature of the 10× photobleaching lines meant that even if the lens was not in the perfect Z-axis position, lines would still reliably be seen in the gel.

While the 40× hourglass-shaped photobleaching mark has significant benefits, particularly in encoding depth information (Section C2), it also demands significantly stricter tolerances for Z-axis accuracy. Consequently, photobleaching marks are shorter, and can easily miss the region of tissue to be photobleached, with detrimental effects on the accuracy of fiducial mark identification. If photobleaching marks are made too high above or too deep inside the tissue, the flared tails of the hourglass shape will overlap with one another, obscuring mark identification. This poses a significant challenge, and component pieces of the solution are addressed in Section B2 (flattening of the tissue) and Section D (utilizing a surface detection algorithm).

### C1.3) Results

FIG. 19 is an annotated example of cellular-resolution co-registration. Co-registered cells are depicted with black arrows. Panel (a) shows a histology slide and panel (b) shows the corresponding co-registered OCT plane.

However, in order to confirm cellular-resolution co-registration, it is insufficient to generate a single matched OCT/histology image pair. While the odds of identifying a false match are extremely low due to the unique distribution of cells within the tissue, to have true confidence in co-registration, multiple adjacent histological sections must be co-registered to multiple adjacent OCT 2D slices.

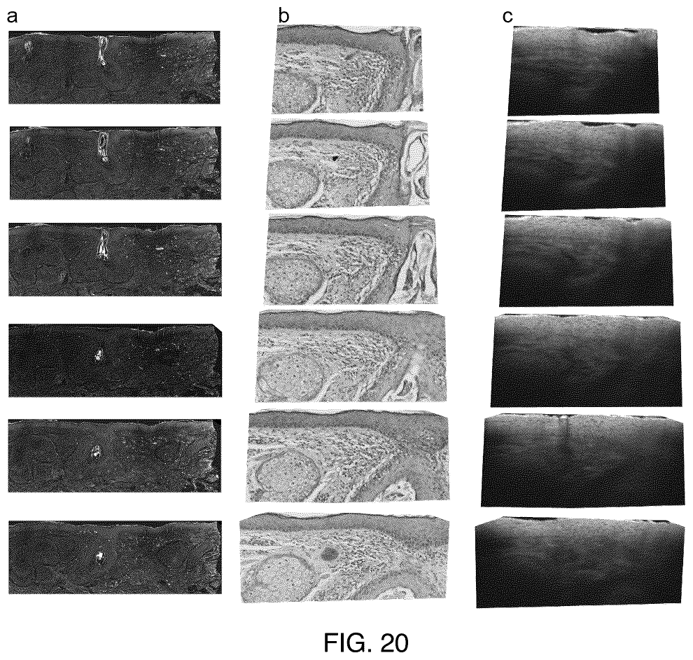

This multi-section validation is shown on FIG. 20 which is a demonstration of cellular-resolution co-registration across six sequential sections. Here column a shows fluorescent histology sections with fiduciary markers identified, column b shows cellular co-registered histology images, and column c shows the corresponding cellular co-registered OCT images.

In FIG. 20 cellular-resolution co-registration is demonstrated in six sequential sections from the same sample. In all sections, the location of OCT follows a progressive trend, with low fluctuation in the XY angle and Z-tilt. Each co-registered section location is sequentially ordered, advancing a predictable distance between OCT 2D planes for each section. This is further validated by corroboration with the histology tracking performed during 2nd iteration sectioning. By identifying unique cellular patterns in image pairs across multiple sequential sections, the co-registration accuracy can be validated.

### C2) XY Pattern

Accurately aligning photobleached barcode marks in histological sections to a known 3D coordinate system is an important step in reconstructing tissue structures and co-registration between imaging modalities. If one is to accurately map 2D histology sections to a 3D coordinate system, one should consider the complications related to:
(A) local section distortion,
(B) lack of consistent and reliable landmarks for alignment, and
(C) deformation in sectioning planes

In some preferred embodiments, these challenges are overcome by photobleaching barcode pattern(s) having multiple distinct depths directly into fluorescent veiled tissue. These new barcode patterns will be referred to as the “XY-pattern”. After veiling, 3D optical coherence tomography (OCT) imaging and histological sectioning are performed. Then, histology sections are imaged and the barcode location and depth information are collected for alignment. With the alignment data, affine or elastic geometric transformations are applied to the histology images, mapping them to the 3D coordinate system of the 3D OCT image volume. The objective is to translate the distorted 2D coordinates observed in the histological image back into their original, undistorted 3D coordinates as defined during the photobleaching process.

In previous work utilizing photobleached barcode patterns for multimodal co-registration, barcode patterns were photobleached in a single plane in fluorescent gel. During processing, the fluorescent gel containing the photobleached barcode would shift over time, resulting in unreliable fiducial markers for alignment. On the other hand, the current method allows for photobleaching of barcodes directly in tissue, capturing the distortion of the tissue through histological processing and sectioning, solving challenges (A) and (B). Additionally, previous work utilized a barcode design limited to a single z-depth and estimated histology section location within a single plane, our current method uses the XY-pattern, which encodes coordinates across multiple z-depths through a series of “hourglass” lines, solving challenge (C). These lines allow us to infer the 3D location of points, including depth, in the histological section simply by identifying the center of the hourglass in the photobleached lines. We then track elastic deformation of the planes created by the histological sections. This is beneficial for multi-modal cell-level co-registration and spatial analysis of tissue, because it allows more accurate co-registration between modalities

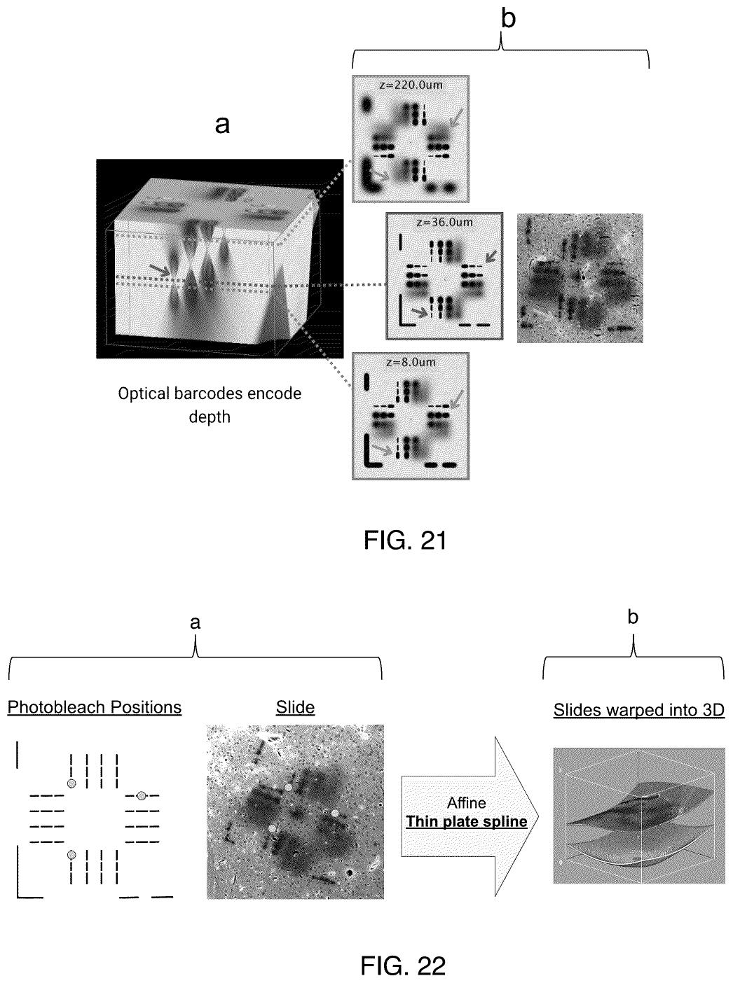

FIG. 21 shows on panel (a) a 3D reconstruction of the XY-pattern template with an XZ cross-section view showing the photobleached lines. The cross-section highlights the “hourglass” shape of each line, which encodes depth based on the position of the line's narrowest point. Panel (b) of FIG. 21 shows sequential XY slices of the 3D XY-pattern template, demonstrating how specific z-depths correspond to positions within the hourglass structure. The thinnest point of each line marks the encoded depth, serving as the z-reference for registration.

To initiate the alignment process, fluorescent histological sections containing the XY-pattern and the XY-Pattern template are manually annotated. Corresponding centers of photobleach lines are matched and their coordinates are recorded.

### C2.1) Alignment Frameworks

### C2.1.1) Affine Transformation

Affine transformations provide an efficient method to approximately align histological sections by correcting for global distortions such as translation, rotation, scaling, and shear. These transformations are appropriate when the tissue deformation is minimal and can be represented as a uniform linear transformation across the entire field of view.

An affine transformation is defined as:

$$[ \begin{matrix}{q}_{1} \\ {q}_{2} \\ 1\end{matrix} ] = [ \begin{matrix}{a}_{11} & {a}_{12} & {a}_{13} \\ {a}_{21} & {a}_{22} & {a}_{23} \\ 0 & 0 & 1\end{matrix} ] [ \begin{matrix}{p}_{1} \\ {p}_{2} \\ 1\end{matrix} ]$$

where the parameters a₁₃ and a₂₃ define its translation and parameters a₁₁, a₁₂, a₂₁, and a₂₂ define its scaling, shearing and rotation.

The goal is to compute the a values such that the transformed observed points best match the known fiducial coordinates derived from the barcode template. This is achieved by solving a linear least-squares system.

This outputs the transformation matrix and translation vector that minimize the sum of squared errors between predicted and known coordinates. The affine model is then applied uniformly across the image, mapping all pixels to their new positions.

In addition to computing the in-plane (x, y) alignment, we can estimate the tilt of the photobleached barcode plane using a linear fit of the known 3D coordinates of the barcode landmarks. Each fiducial marker has an associated depth known from the barcode template. A best-fit plane is computed by solving z=ax+by +c.

This system is solved using least-squares to determine the normal vector

$$n = \frac{{[ - a , - b , 1 ]}^{T}}{‖ [ - a , - b , 1 ] ‖} ,$$

which describes the plane's orientation in 3D space. This normal vector allows for validation of how closely the histology sections' observed matches the expected orientation of the barcode in tissue.

Despite being highly computationally efficient, the affine model is limited when applied to biological tissue. In reality, the tissue undergoes varying-localized distortions during histological processing, such as bending, stretching, and compression. Affine transformations are unable to capture these nonlinear deformations, resulting in a higher registration error. Therefore, we have moved toward elastic transformations as our default alignment approach.

### C2.1.2) Elastic Transformation

To address the complicated distortions introduced during histological processing, we apply a non-linear transformation known as thin plate spline (TPS). This approach allows precise alignment of XY-Pattern points between the distorted 2D histology image and the known projected coordinates derived from the original 3D photobleaching template.

To compute the TPS transformation matrix, let {pᵢ}^{N}_{i=1,N} be a set of 2D landmark coordinates in the histology image, and {qᵢ}^{N}_{i=1,N} be the corresponding target coordinates from the XY-pattern template. The TPS function ƒ: [symbol] ²→ [symbol] ² maps the input coordinate x to a new location ƒ(x):

$$f ( x ) = Ax + {\sum }_{i = 1}^{N} {w}_{i} U ( ‖ x - {p}_{i} ‖ )$$

$$Where :$$

$$U ( r ) = {r}^{2} log ( r )$$

wᵢ are the weights of each anchor point
A is a matrix that defines the affine mapping.
   To solve for the weights and affine coefficients, we solve the following linear system:

$$[ \begin{matrix}K & P \\ {P}^{T} & 0\end{matrix} ] [ \begin{matrix}W \\ a\end{matrix} ] = [ \begin{matrix}Q \\ 0\end{matrix} ]$$

$$where$$

$${K}_{ij} = U ( ‖ {p}_{i} - {p}_{j} ‖ )$$

for the anchor points W and affine coefficients a.

### Here

P=[1, xᵢ, yᵢ]^{T} is the matrix of linear transformation
W are the weights of the non-linear TPS weights
Q is the matrix of target coordinates ({qᵢ})
   This method interpolates the landmarks exactly while minimizing the bending energy, producing a smooth surface mapping that can be applied across the entire image domain.

### C2.1.3) Z-Coordinate Mapping

Although the TPS model operates in 2D space, it is integrated into a 3D tissue reconstruction by associating each transformed 2D point with its original z-coordinate from the barcode design. This does not produce a flat plane like with affine models, but a curved plane that represents tissue distortion.

After warping the fiducial positions (xᵢ, yᵢ) to (x′ᵢ, y′ᵢ), we associate the known z-coordinates associated with each barcode: (x′ᵢ, y′ᵢ)→zᵢ

These combined coordinates represent a nonlinear 3D surface through the tissue. The surface can be visualized using scattered data interpolation (e.g., cubic interpolation) to form a continuous, elastically warped plane that more accurately represents histological deformations. This 3D surface captures factors that cannot be represented by a linear plane. It is able to capture local variation in sectioning angles, curved warping, and depth deviation. The output is not a best-fit plane, but a TPS-warped slice that reverses distortion caused by histological processing, preserving true anatomical structures across histology sections.

FIG. 22 shows on panel (a) a template of an exemplary XY-pattern with example annotated anchor points used for transformation, alongside a corresponding histology section containing the photobleached pattern. Panel (b) of FIG. 21 shows histology sections after 3D elastic transformation with TPS, localized in a reconstructed 3D coordinate space. Similarly, other elastic models can be applied to the histology sections such as B-spline.

### C2.2) OCT-to-Histology 3D Alignment and Validation

Once the histological sections have been aligned in 2D via the barcode pattern and positioned in 3D using the provided z-depth information, we generate a 3D histology volume using our reconstruction code. This volume reflects the same spatial orientation as the original OCT-imaged tissue block.

To align the OCT volume to the 3D histology reconstruction, we compare anatomical landmarks visible in both modalities. Specifically, we extract a 2D slice from the reconstructed histology volume at a given depth, and compare it to a corresponding 2D slice from the OCT volume. Features such as vascular structures, individual cells or clusters, or tissue boundaries are manually matched between the two images.

Using a cell-level matching, corresponding cells and features are identified between OCT and histology images. The alignment error is then found by computing the distance between each matched pair. Small average distances in the majority of selected features (e.g., under 5 μm) indicate good alignment.

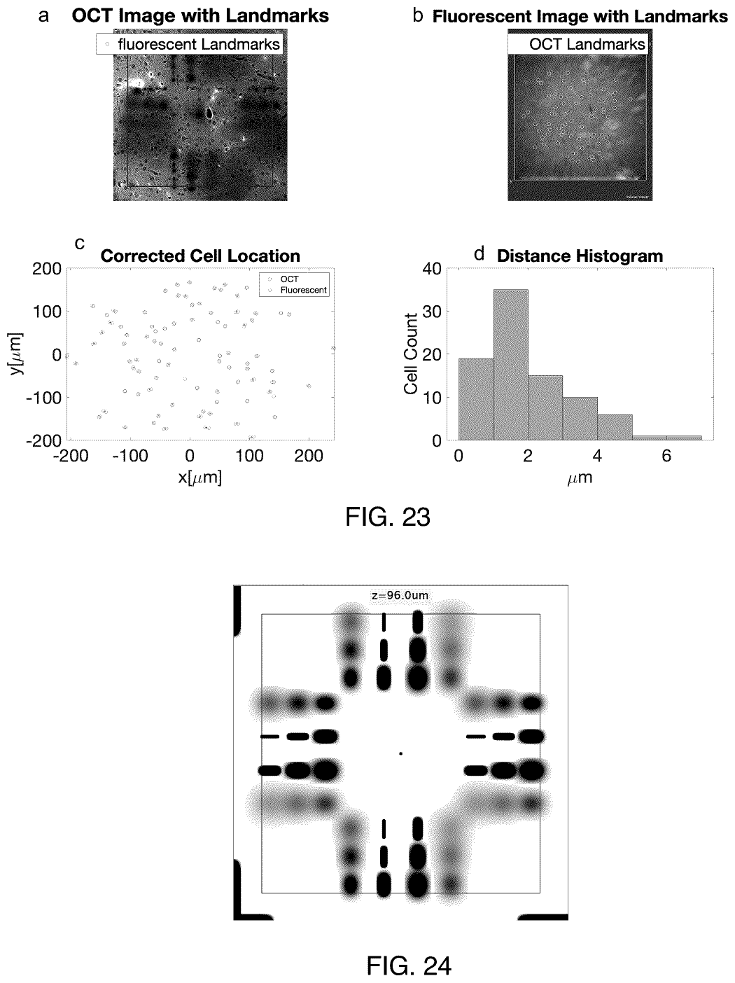

FIG. 23 shows some representative results. Here panel (a) shows an OCT image with manually selected landmark cells. Panel (b) shows fluorescent histology image with matched barcoded cell locations. Panel (c) is a scatter plot of aligned cell pairs from OCT and histology sections. Panel (d) is a histogram showing the distribution of distances between matched cells. Most cell pairs show alignment errors below 0.5 μm, indicating high registration accuracy.

### C2.3) XY-Pattern Design

### C2.3.1) Presently Preferred XY-Pattern

FIG. 24 shows a template view of the presently preferred XY-pattern, annotated with depth encoding. Thin regions of the photobleached lines indicate the focal depth (the center of the hourglass), while wider regions correspond to positions away from the encoded z-depth. This shape-based encoding is how depth is inferred from 2D histology. In this particular image, the XY-pattern encodes a depth of 96 μm below its initial photobleach line.

The presently preferred version of the XY-Pattern contains a total depth from 0 μm to 220 μm. A 2D view of the pattern, excluding z-depth, is shown in FIG. 24. The full pattern is made up of four smaller repeating units called sub-barcodes. Each sub-barcode has one neighboring barcode that is a mirrored version of itself and one that is not. Sub-barcodes on opposite ends of the full pattern are also mirror images of each other. Within each sub-barcode, there are twelve individual lines, starting at 0 μm and increasing in depth by 20 μm steps. This creates a set of lines that reach 220 μm beneath the initial photobleached lines.

### C2.3.2) XY-Pattern Versions Tested

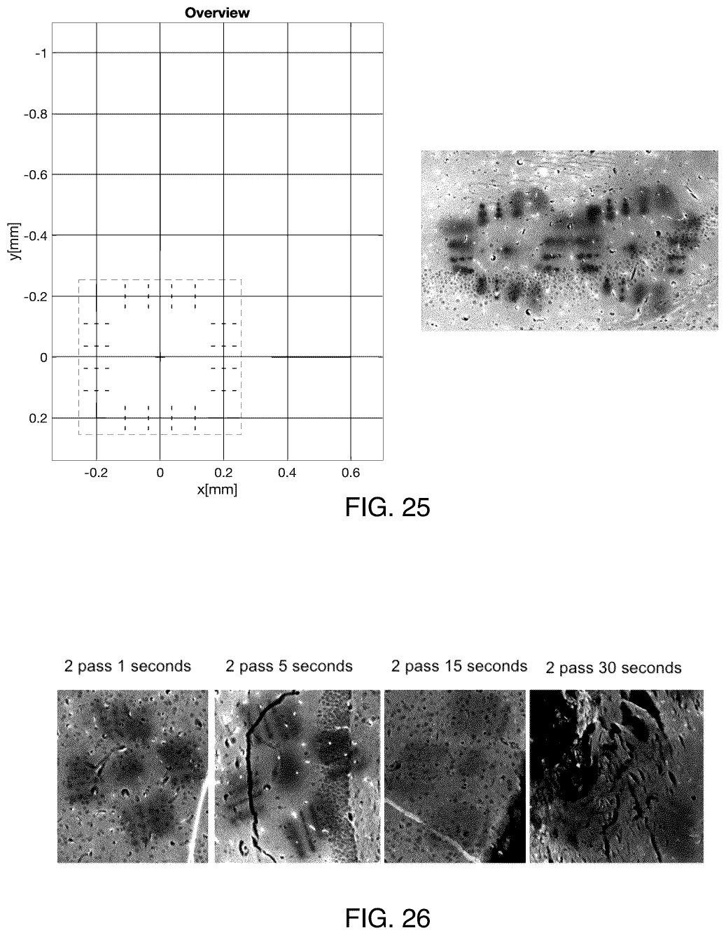

To support flexibility of use across tissue types, imaging setups, and alignment needs, our method allows for flexible design elements of the XY barcode pattern. Each pattern iteration is developed and tested with variations in spatial layout, depth encoding, and photobleaching intensities and exposure times to assess effectiveness for co-registration. FIG. 25 shows one such example, where the left side is the spatial layout and line configuration, and the right side is a corresponding appearance of the pattern in histological brain sections. Design parameters vary in number of lines, depth range, spacing, and spatial layout.

FIG. 26 is a qualitative comparison of different photobleaching exposure times and number of passes used to optimize barcode visibility in mouse brain tissue. For fixed mouse brain tissue in this example, the optimal exposure time is 5 seconds and the optimal number of passes is two.

### C2.3.3) XY-Pattern Design Flexibility

The XY barcode pattern system allows for flexibility in spatial placement and customization. Patterns can be placed at any (x, y) coordinate within and outside the OCT imaging area. This allows multiple XY-patterns to be patterned across the tissue in various locations, allowing larger tissue regions to contain spatial information. OCT imaging can be aligned either directly with the photobleached regions and/or the space between them. The (x, y, z) placement of each barcode is chosen based on anatomical structures, imaging field of view, and region of interest.

Additionally, individual pattern parameters, such as the number of encoded depths, line spacing, and overall size, can be adjusted. The XY-Pattern protocol can be adapted to a range of biological and experimental needs. This pattern can be adapted for any biological tissues such as human skin.

### C3) Z Pattern

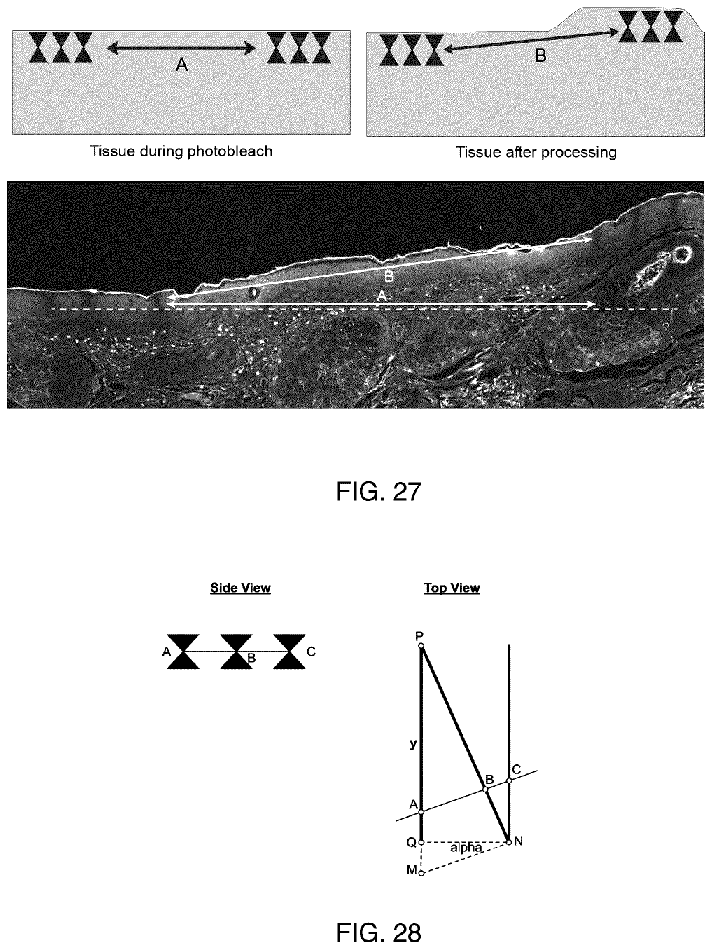

One pattern that has been previously considered for bar coding tissue samples has two sets of lines, vertical (V) and horizontal (H) lines and utilizes the relative distances between the lines to estimate the 2D plane. However, in many cases the H and V lines are relatively far apart from each other, and are subject to different local deformations. The top part of FIG. 27 schematically shows an example of this effect. During photobleaching (top left) the distance between H&V lines is A, however after tissue processing local deformations increases this length to B (top right). A real world example is shown in the bottom part of FIG. 27. Such deformation often limits the accuracy provided by such patterns to tens of microns.

Here we present an alternative pattern that can bring the accuracy to single digit microns. The improved pattern has a Z shape as shown on FIG. 28. Two parallel line segments are photobleached at positions x=q and x=n, and in depth z=z0. We define the length PQ as L, and distance QN as D.

Each plane individual 2D cut will identify three photobleach points: A, B, C.

We can show that the distance between A and P (denoted as y) in the plane is approximated as:

$$y = L ⋆ AB / AC \qquad ( Eq . 1 )$$

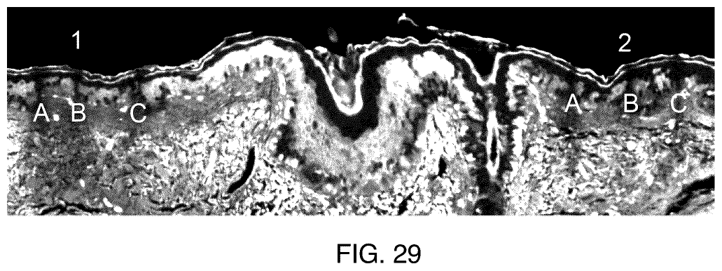

As a result, we can pinpoint point A in the fluorescence image to 3D space:
A is located in (x, y, z)=(q, y, z0).
By placing a few z patterns along the tissue, we are able to pinpoint several positions along the image. FIG. 29 shows an example fluorescence image cross section of two Z-patterns.

We can then fit a linear plane or flexible manifold through all A points in the image. We note that in earlier work we had to introduce the uniform shrinkage and non-shearing assumptions to solve the equations that predict the 3D plane. In this pattern, we don't need those assumptions anymore, providing a more generic solution.

We note that Eq. 1 is only an approximation of y, a more exact formula is:

$$y = ( L + D * tan ( α ) ) ⋆ AB / AC \qquad ( Eq . 2 )$$

which implies an uncertainty or error term: D*tan (α)*AB/AC.

The error term varies as response of the cut angle α, the distance between the photobleach parallel lines (D) as well as cut position (AB/AC is proportional to the cut position).

It is therefore recommended to place multiple Z patterns in the tissue that have different L/D ratios as well as different origin y position (see image on the right), and different photobleaching depths (we used z0=0 up to z0=100 microns)

FIG. 9 shows an exemplary Z-pattern for photobleaching.

FIG. 10 shows corresponding results: Here panel (a) is the generated overview grid, detailing the XY coordinates of the fiduciary markers relative to the OCT. Panel (b) is a fluorescent image of a histological section collected from this sample. Its position in the tissue's XY plane is denoted with a dotted line in part (a) of FIG. 10. Clearly visible within the epidermis is the characteristic hourglass shape of the 40× fiduciary markers. Panel (c) is another fluorescent image of a histological section collected from this sample. Its position in the tissue's XY plane is denoted with a dashed line in part (a) of FIG. 10.

### C4) Matching Cell Features

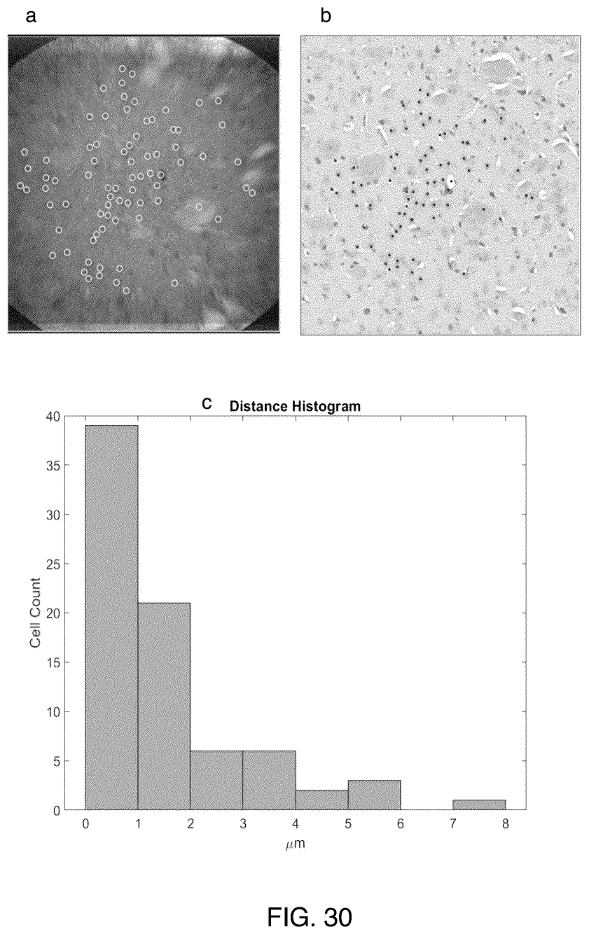

Following the co-registration using the photobleach markers, some errors can remain. In the example of FIG. 30, we manually identified and selected cell centers at the 3D OCT volume (panel (a)) and compared those to the 2D registered section—in that case a histology image (panel (b)). A histogram of the resulting residual errors is shown on panel (c).

In some embodiments we use as automated algorithm to:
1) Identify cell centers in both modalities;
2) Link the same cells between the modalities to each other. Here we can use simple Iterative Closest Point Algorithm (ICP); and
3) Further morph 2D imaging modality to better match the 3D imaging modality in the subcellular accuracy—e.g., using any or any combination of the other methods described herein.

Several approaches are considered to identify cell centers:
1) Utilizing off-the-shelf algorithms such as: CellProfiler or HoverNet. However these are often pre-trained per imaging modality and require adjustments per image.
2) Utilizing interactive semi-automated segmentation tools such as nnInteractive. These tools allow users to guide segmentation with minimal input, and can be applied to a wide range of imaging modalities without additional model fine-tuning.
3) Utilizing one-shot style transfer provides effective results when the given examples represent similar morphological tissues. In this approach, we leverage the optical barcode-based coarse registration to achieve an approximate alignment between the 3D and 2D modalities. Subsequently, we apply style transfer techniques to transform the 3D image into a visually similar representation of the 2D modality. Following this transformation, optical flow methods are employed to refine and compute sub-pixel accurate registration between the two modalities.
4) This third method is particularly advantageous when the 2D modality is a widely utilized imaging technique, such as hematoxylin and eosin (H&E) staining. Common imaging modalities typically have advanced machine learning models capable of effectively identifying and segmenting cellular structures and other morphological features. Conversely, 3D imaging modalities often lack similarly sophisticated algorithms. By converting the 3D modality to closely mimic the 2D style, standard machine learning segmentation models, already optimized for 2D images, can be efficiently applied to both modalities, significantly improving the accuracy and consistency of the alignment.
5) Finally, we can use Reverse-Augmented Generation (RAG) to identify cell centers in the image utilizing a large visual transformer (VIT) model such as MUSK (Multimodal transformer with Unified masKed modeling) or CLIP (Contrastive Language-Image Pretraining). We note that MUSK and CLIP are unable to identify cell centers per-se, but when we provide a few examples of cells in the image in a small patch (either 2D or 3D modalities), then RAG can identify most of the other cells in the sample.

After cells have been identified in both the registered section and OCT images, feature vectors can be extracted for each cell. These features may include geometric descriptors such as cell centroid location, shape eccentricity, area, solidity, or local texture-based descriptors such as SIFT (Scale-Invariant Feature Transform).

Cell pairs can then be identified by matching these features using a distance metric or assignment algorithm, such as weighted Euclidean distance, Iterative Closest Pair, or the Hungarian algorithm. When using SIFT descriptors, key points can be created from each detected cell centroid and matched across modalities based on descriptor similarity. Once matched, cell pairs can serve as control points to estimate a fine-scale second-stage transformation to further refine the initial coregistration between the images.

### D) Sample Surface Detection

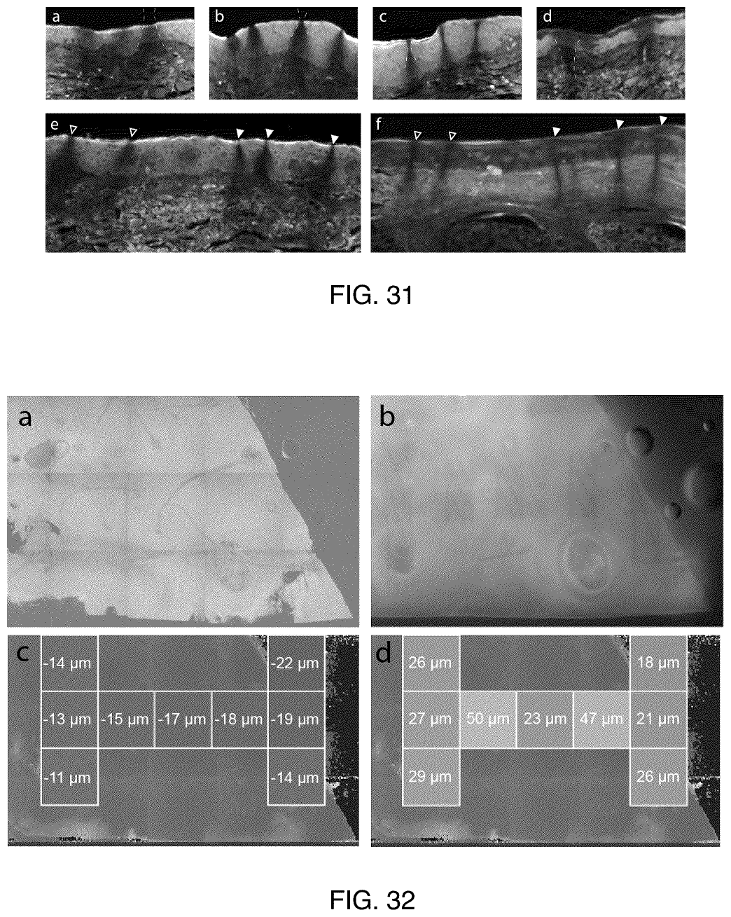

Accurate co-registration depends on precise fiduciary markers. Larger marks encode less spatial detail than smaller ones. To enable cell-level co-registration, large tissues must be photobleached with micron-scale markers. However, photobleaching is often performed on the tissue's external surface, which is often irregular or uneven. These micro-deformations can lead to marks being misplaced, either above the tissue or too deep in it (FIG. 31), especially when targeting specific depths or wide areas (small leveling misalignment angles cause large Z-position inaccuracy at the periphery). The accuracy of fiducial analysis depends on clear identification of the center of the hourglass. An algorithm to detect and correct for surface variation is thus employed in preferred embodiments.

FIG. 31 shows fluorescent sections showing the effects of photobleaching at different Z-depths. Panel (a) shows photobleaching above the tissue surface: only hourglass tails are visible, the center is absent. Panel (b) shows focusing at the tissue surface. The hourglass center appears but lacks clear definition. Panel (c) shows focusing within the epidermis. The entire hourglass shape is visible. Panel (d) shows focusing within the dermis. The center is obscured by background heterogeneity. The upper tails overlap in the epidermis.

Panels (e) and (f) of FIG. 31 show a side by side comparison showing the benefit of surface detection. Panel (e) shows bleaching without surface detection: Fiduciary markers intended for 40 μm (outline triangles) and 65 μm (solid triangles) have depths that are too shallow, resulting in poor visibility. Panel (f) shows bleaching with surface detection: markers are placed at their intended depths, showing clear full hourglass centers.

Photobleaching the currently preferred XZ pattern in skin only works as expected when every laser pass strikes the tissue at ˜40-65 μm depth, regardless of local bumps and glare. Achieving that across millimeters of specimen requires an algorithm that simultaneously defeats five failure modes that simple thresholding or autofocus cannot. The TSD-Algorithm described below automatically transforms any OCT intensity stack into a column-wise depth map while never commanding a Z-move that exceeds its 100 μm safety envelope.

Key constraints and the layered fix: Photobleach-line uniformity should satisfy all of the following simultaneously: Cover-glass glare can raise a 5-130 μm false ridge; instead of trusting the brightest voxel, the TSD-Algorithm accepts a surface only if ≥12 μm of uninterrupted sub-threshold tissue lies beneath it. Because stitched tiles drift ±15 dB in brightness, a fresh Otsu threshold is computed per tile and sanity-checked before use. Residual topography (10-40 μm) is handled in two stages: TSD (i) records a per-column Z-offset to compensate for ordinary bumps and (ii) aborts any field whose remaining curvature exceeds a focus tolerance preventing blur. OCT speckle inserts salt-and-pepper peaks that fool edge filters; once the surface is locked, a light Gaussian polish suppresses noise without flattening real ramps. Finally, aggressive Z corrections can crash optics; every move is hard-clamped to ±100 μm. No single classical primitive threshold, gradient or autofocus routine satisfies all five conditions; the layered TSD-Algorithm does, which is why it keeps the laser at the intended 40-65 μm depth across millimeters of uneven tissue.

General Order of Operations: The operator first captures a stitched OCT log-intensity volume with a desired area at 1-25 μm voxel pitch. The OCT scanner provides real-world coordinate arrays for every voxel; the location the user designates as “focus-zero” is stored as (0,0,0) after which all axes are converted to millimeters so downstream code is unit-free. If the requested scan footprint is wider than a single lens field-of-view (typically 0.50 mm with a 40× objective or 1 mm with a 10×), the software auto-tiles and stitches before analysis. The TSD-Algorithm then returns a millimeter-true 2-D surface map covering the scan; the photobleach routine may use that full map or collapse any region-of-interest to a single median Z-offset when only one correction value is needed.

Speed and Resolution Trade-off: Bench tested on a consumer i7-9700K 64 GB workstation. With 1 μm in-plane sampling the algorithm processes a 1024×500× 500 stack in ˜5 min; we treat that run as the baseline reference. Coarsening the XY pitch to 10 μm collapses the data cube to 1024×50×50 and slashes runtime to 24 s while reproducing the baseline surface within numerical precision (0 μm deviation). A further step to 15 μm shrinks runtime to 19 s and still holds the error to 0.1 μm. At 20-30 μm the pass completes in 14-17 s but residual error rises to ≤11.5 μm; usable only if a looser depth budget is acceptable. Pushing to 50 μm (12 s) breaks the method-surface indices devolve to NaN-so this setting is rejected. In practice, 10-15 μm is used for speed; 1 μm is reserved for ground-truth benchmarking.

### Surface-Identification Logic

Tile awareness: Each large mosaic is built from several partially-overlapping OCT tiles. Because laser power drifts, one tile can be ˜ 15 dB brighter than its neighbor. The algorithm therefore starts by counting how many full lens fields of view span the X-direction, approximately (scan-width/FOV). From that point on every intensity threshold and sanity-check is executed per tile, not globally. Treating tiles independently eliminates brightness-drift traps that would otherwise mis-place the surface.

Adaptive tissue-air thresholding: For every Y-slice inside each tile the algorithm crops a small, central region of interest, runs Otsu's method on that subset and stores the resulting grey-level as the tile-specific threshold (τ). Because Otsu is recalculated per tile and per slice, τ rides naturally on any local exposure change. A fixed safety margin Δ≈10% of that tile's dynamic range is added so that later confirmation tests can tolerate noise while still rejecting >99% of background air pixels.

Column-wise surface search with confirmation: Each A-scan (one X-column through depth) is examined from a starting depth Z₀ (approximately 300 px below surface for deeper stacks, or at the top pixel otherwise) moving downward voxel-by-voxel. When a voxel rises above τ it is treated as a provisional surface only if the next N consecutive voxels (initially N=12, relaxed to 9 in dim regions) also remain above (τ−Δ). The first depth that survives this confirmation is recorded as the local surface; if no voxels satisfy the rule the column is marked unknown (NaN) so downstream stages can ignore it rather than propagate an error. The N-voxel test suppresses single-pixel glare spikes, while the adaptive relaxation prevents legitimate columns from being discarded where the signal is weak.

Speckle-aware contour smoothing: The per-column depths may form a jagged surface because OCT speckle injects salt- and -pepper noise. To polish the map without flattening real bumps, the algorithm convolves the depth matrix with a σ≈1.5 px Gaussian kernel (3 σ support). Before convolution, NaNs are temporarily replaced by zeros; afterwards the result is renormalized by the local count of non-NaN entries and the NaNs are restored. This procedure damps random spikes while leaving genuine slopes and discontinuities intact, yielding a gently undulating 2-D surface.

Conversion to millimeter-true coordinates: Each voxel's depth coordinate is already known because the OCT metadata include an absolute-depth lookup table. After smoothing, the algorithm simply replaces every valid pixel index with its corresponding physical depth from that table, yielding a surface-depth map expressed directly in millimeters and aligned to the original X- and Y-axes. Because the map is already in stage units, the downstream control software can issue Z-offset commands to the hardware without doing any additional unit conversions or scaling. Depth conversion honors sample refractive index (n=1.33 for aqueous, n=1.40 for lipid-rich tissue).

Automatic adjustment of Z-offset based on FOV: To translate the millimeter-scale surface map into one practical command for the Z-stage, the algorithm runs a small post-processing routine. It begins by defining a region of interest (default=the full scan, but the operator can crop). Within that ROI, it calculates the median of all valid surface depths and negates it, ensuring a positive offset means “move the laser downward into the tissue.” The proposed move is then sanity-checked: if more than 20% of the ROI is undefined, or if over 80% of the surface points lie outside ±25 μm of the median, the run is flagged as “unreliable.” Even when the surface looks acceptable, any single commanded move is hard-clamped to ±100 μm to protect the objective. If the offset passes these tests it is sent straight to the stage; otherwise the algorithm alerts the user (or, in automated mode, triggers a re-focus routine) so that photobleaching never proceeds on a doubtful or potentially damaging correction. Any accepted offset translates into a stage move typically 1-30 μm for 40× lenses (sub-micron resolution supported) and, as noted above, is hard-clamped to ±100 μm for optic safety.

FIG. 32 is a demonstration of photobleaching fields of view, surface detection and Z-correction. Here panel (a) is an XY OCT image of skin tissue used to identify the surface. Black ROIs mark photobleaching fields of view. Panel (b) shows XY fluorescent image post-photobleaching. Panel (c) shows detected tissue surface positions relative to the baseline Z-position. Panel (e) shows final corrected Z-positions for each ROI, adjusted based on local surface detection.

User-Validated Surface Detection: A test was performed to validate the surface detection algorithms accuracy. The tiled overview OCT scan used by the surface detection algorithm was evaluated by a user. The user estimated the surface location for each photobleaching field of view, and the results were compared with the algorithm's assessment, giving an insignificant average difference of 2.29 μm.

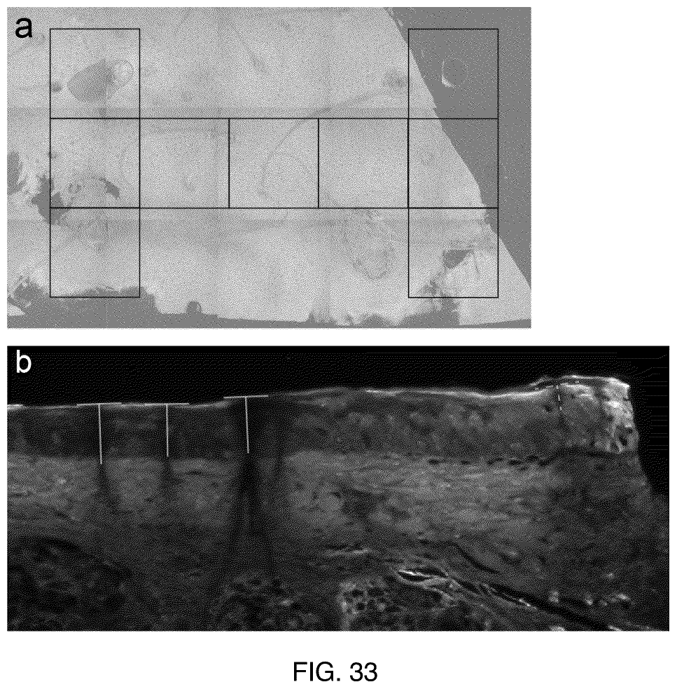

FIG. 33 shows an example of user validation of surface detection. Here panel (a) shows the XY overview OCT image and photobleaching FOVs. Panel (b) shows analysis of photobleaching depths in fluorescent sections, examining marks photobleached at 40 and 65 μm (˜28 and 45.5 μm when accounting for 30% shrinkage in histology). Depths were measured by identifying the surface plane and drawing a perpendicular line to the hourglass center. Physical depth was calculated using known pixel size. Marks requested at 65 μm were measured at 51, 47 and 46 μm (solid lines), close to the expected 45.5 μm. The mark requested at 40 μm (dashed line) was measured at 21 μm, consistent with the expected 28 μm.

Validation summary: After hand-tuning the two free parameters (confirmation length N and safety margin 4) on 200 stitched training volumes drawn from human skin, mouse-brain and ECM-scaffold scans, we froze the algorithm and challenged it with a 20-image “stress-test” set deliberately assembled to break simple thresholding: multi-tile mosaics, mixed voxel sizes, strong cover-glass glare and steep native topography. For each volume we compared the algorithm's surface to a pixel-accurate mask traced by a blinded annotator, yielding approximately 10,000 independent A-scan columns for analysis:
Mean absolute error: 1.7 μm—the average departure from ground truth.
Median error: 2.0 μm—half of all estimates are within two microns.
90th-percentile: ≤6 μm—nine out of ten columns sit inside a six-micron band.

The error distribution is sharply left-skewed; only a long, low-amplitude tail extends beyond 6 μm, and every measurement remains well inside the ±25 μm photobleach-visibility window. These results confirm that, even on worst-case specimens, the TSD-Algorithm delivers subcellular accuracy without manual intervention.

### E) Iterative Sectioning and Bleaching

If one is to accurately reconstruct a large-volume of 3D histological data using optical barcoding, one should consider the complications related to photobleach laser penetration depth. Our standard photobleaching protocols are limited by laser penetration depth due to tissue scattering and absorption, typically to a maximum of approximately 200 μm, which restricts photobleach patterning (also referred as “optical barcoding”) to superficial regions of tissue. To reconstruct structures deeper and larger in the sample, multiple photobleaching rounds must be applied iteratively after serial histology sectioning. However, this introduces significant alignment challenges.

Each round of photobleaching occurs on a newly exposed tissue surface, requiring re-registration of the tissue in the photobleaching apparatus. Small angular misalignments can accumulate between barcoded rounds, especially when the tissue is removed and repositioned in between steps. Additionally, minor tilt differences in histological sectioning introduce further variability. Thus, ensuring that the planes of photobleach patterning and histological sectioning are consistent over multiple rounds is a difficult challenge requiring precise mapping of tissue geometry and image-based quantification.

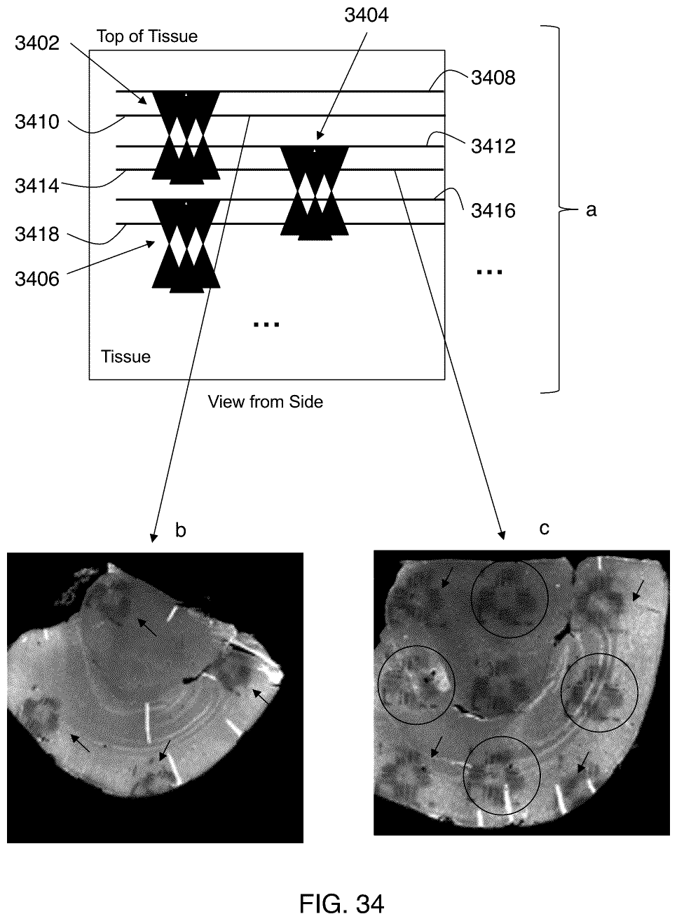

FIG. 34 is a visualization of barcode pattern depth encoding. Panel (a) is a schematic diagram shows photobleached barcode lines 3402, 3404, 3406 embedded at various z-depths within the tissue volume, illustrating the “hourglass” geometry that encodes depth information. Below this schematic, two histological sections are shown: the image of panel (b) containing photobleached barcodes from Round 1 only, and the image of panel (c) containing barcodes from both Round 1 and Round 2, highlighting the cumulative layering of spatial information across rounds. Here 3408 was the exposed surface when round 1 was bleached, 3412 was the exposed surface when round 2 was bleached, and 3416 was the exposed surface when round 3 was bleached. Any number of repetitions can be performed. Features 3410, 3414, 3418 are exemplary sections corresponding to the first, second and third rounds, respectively.

Due to limitations in imaging depth and laser penetration, our ability to reconstruct large 3D histological volumes from serial 2D sections is restricted. In our observations, the photobleaching laser penetrates up to 200 μm from the surface of the tissue. As a result, a single round of photobleaching only allows for reconstruction over a 200 μm z-depth. To overcome this, we developed a multi-round photobleaching and sectioning protocol for use in some embodiments.

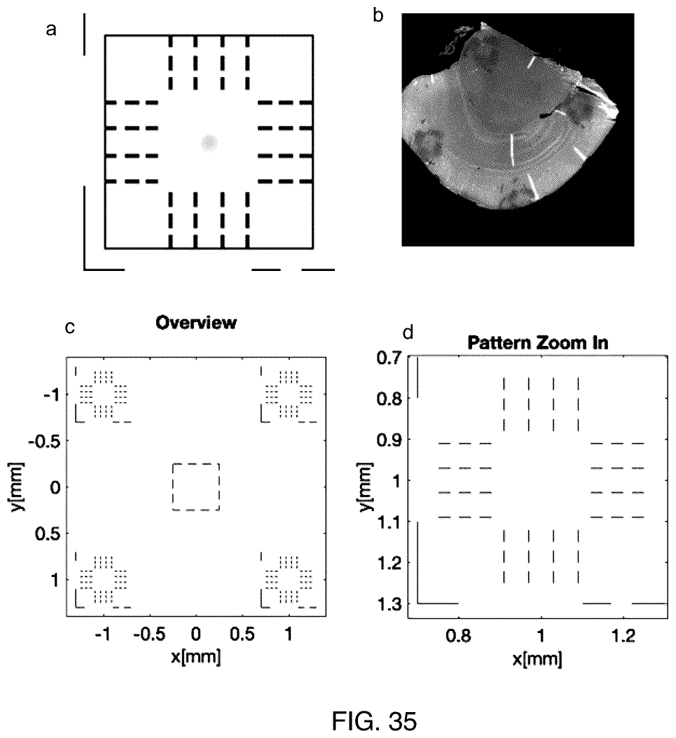

The round 1 bleaching etc. is substantially as described above in section C2 (XY pattern). FIG. 35 shows exemplary round 1 results. Here panel (a) shows the flattened photobleach pattern design based on an XY barcode template. Panel (b) is a representative histological section with visible barcodes. Panel (c) is a diagram of barcode placement within the tissue's coordinate system alongside a graphical representation of barcode scale and positioning. Panel (d) is an enlarged view of the bar code pattern.

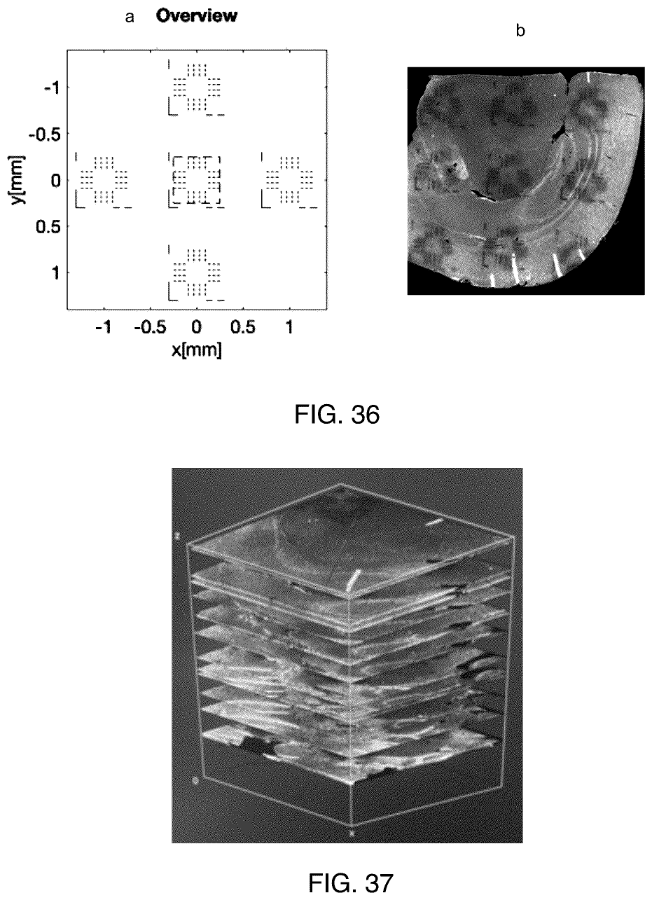

Subsequent Rounds (Rounds 2 and beyond): After sectioning, the freshly exposed surface undergoes a second photobleaching round. Due to the now changed refractive properties of the sample being embedded in paraffin wax, the laser depth of penetration is decreased. Therefore, the photobleach exposure time is increased to 20 seconds per mm and is repeated four times per photobleached line. Round 2 photobleaching patterns will be arranged in “pattern placement #2” (FIG. 36, panel (a)). For each consecutive round, pattern placements will alternate between “pattern placement #1” and “pattern placement #2” to avoid photobleaching over existing patterns between adjacent rounds. These steps can be repeated iteratively across rounds until the desired 3D depth is covered. Typically six rounds are performed to achieve our desired z-depth of ˜1 mm. The only variation in protocol among rounds is in the final round, where histology sectioning to 220 μm is performed.

FIG. 36 shows Barcode pattern placement and photobleaching for Round 2. Panel (a) is a Diagram showing the barcode placement on the coordinate system for the second photobleaching round, including sizing of the barcode pattern. Panel (b) is a histological section containing corresponding barcodes.

Orientation Preservation: Throughout the photobleaching steps, the tissue remains in an apparatus that maintains rotational and translational consistency. This apparatus includes a plastic histology mold that is anchored to the OCT imaging stage. The compression cassette clicks into the anchored histology mold, maintaining a highly consistent orientation for each round of photobleaching.

Co-registration: co-registration of histology sections from all rounds are aligned to each other and the previously imaged OCT volume using the xy-pattern co-registration method described in Section C2.

Final Outcome: This method enables the collection of millimeter-scale histology volumes embedded with fiducial markers, enabling downstream 3D spatial reconstruction and multi-modal co-registration. We have achieved a z-depth of approximately 1 mm in a mouse brain sample using this method (FIG. 37).

FIG. 37 shows a 3D histological reconstruction from stacked sections. This is a 3D volume rendering created from aligned histology sections across six rounds, capturing structures to ˜1 mm deep.

### E1) Alignment Challenges and Quantification

Due to the nature of multiple rounds of photobleach patterning, histology processing, histology sectioning, and even the introduction of 3D optical coherence tomography imaging (OCT), we preferably take into account additional factors that may affect the co-registration of the histology sections. One unique challenge that multi-round alignment revealed was alignment of all histology sections to create a unified and accurate 3D volume using photobleach patterns with varying tilts.

### E1.1) The Parallel Plane Problem

Ideally, photobleaching planes and histology sectioning planes are all mutually parallel. In practice, we observe small variations in tilt from one round to the next and even between adjacent histological sections. Three key alignment questions arose: Q1: Are histology sections within a single round parallel? Q2: Are histology sections before and after a photobleaching round parallel? Q3: Are photobleach planes in different rounds parallel? To address these, we calculate the orientation of each photobleached plane from annotated fiducials.

### E1.1.1) Computation of Planar Deviation

Each photobleached pattern is fit to a plane, and a normal vector is computed using cross-products of in-plane vectors:

$${n}_{i} = \frac{{u}_{i} \times {v}_{i}}{‖ {u}_{i} \times {v}_{i} ‖} .$$

For a group of planes (e.g., from one round), we compute an average unit normal vector:

$${n}_{avg} = \frac{1}{N} {\sum }_{i = 1}^{N} {n}_{i} ,$$

then normalized the angular deviation of each plane from this average is: θᵢ=cos⁻¹ (nᵢ·n_{avg}). To compare across rounds, we compute:

$$θ = {cos}^{- 1} ( \frac{{n}_{1} \cdot {n}_{2}}{‖ {n}_{1} ‖ \cdot ‖ {n}_{2} ‖} ) .$$

This angle quantifies misalignment between two averaged planes from different rounds.

We applied this analysis to a multi-round annotated mouse brain sample. We established that an angular deviation of 0.5 degrees corresponds to a spatial error of 4.5 μm at the edge of a 1 mm sample, which is comparable to one section thickness. Histology sections and rounds with angular deviations larger than 0.5 degrees would result in adjacent sections theoretically occupying the same space in 3D, which is not physically possible. In our analysis, we proved that photobleaching plane and histology sectioning plane tilts across rounds remain within the bounds of angular deviation
Q1 Findings: When sectioning a block, we assume that each section is parallel to the one before it. However, we recognize that there may be slight angular deviations between consecutive sections. Additionally, inaccuracies in marking the pattern and in selecting the depth for photobleaching can also contribute to misalignment between the planes. When comparing the angles within one round we see that in most cases it's below the threshold we set above indicating very low error for marking patterns as well as cutting within round. Within-round angles were consistently below 0.5 degrees, suggesting negligible sectioning variation.
Q2 Findings: After each sectioning step, we remove the sample to perform a new round of photobleaching and then reposition the block on the sectioning machine to cut additional sections. During this process, there is no guarantee that the sections created before and after removing the sample from the machine will remain parallel to each other. The act of removing and reintroducing the block to the machine may introduce an angular shift in the sectioning process, leading to deviations from parallelism. To measure this error, we compare the angles of the normal vectors of the planes in the samples taken before (Round 1) and after each round. Note that we use the same photobleach pattern to compute the normals in order to avoid photobleach related errors.

Between-round deviations were low but measurable: Pattern 1—Round 1 vs. Round 2:0.221°, Pattern 2—Round 2 vs. Round 3:0.430°, Pattern 3—Round 3 vs. Round 4:0.436°. The average error is low but slightly above our threshold: 0.36 degrees
Q3 Findings: Comparisons between photobleach patterns from different rounds, using the same section and overlapping z-depths, revealed angle deviations similar to Q2:
Pattern 1 vs. Pattern 2 (Round 2): 0.362°
Pattern 2 vs. Pattern 3 (Round 3): 0.289°
   These deviations confirm that even when using the same section plane, photobleaching orientation between rounds can vary slightly. However, all Q3 measurements remained below the 0.5° threshold.

Double-blind annotation of the same tissue sections by two independent annotators revealed the delta-z error of 5.9 μm and an average angle of deviation of 0.22 degrees. These values fall well within the 0.5-degree precision tolerance used throughout the alignment protocol.

### E2) Alternative Methods to Multi-Round Alignment

We have expanded and adapted the multi-round photobleaching patterning protocol to enable its application across a variety of experimental contexts and use cases, particularly in multimodal image co-registration workflows.

### Method 1: OCT Imaging in Fixed Tissue Followed by Paraffin Embedding

Although OCT imaging can technically be performed in paraffin-embedded blocks, the quality and depth of imaging are significantly reduced due to scattering and refraction differences introduced during the embedding process. For this reason, high-quality OCT imaging is typically only performed during Round 1 in fresh tissue. The placement of OCT imaging is flexible within this method and other alternative methods involving OCT imaging. Imaging can be centered directly on photobleach patterns or performed between them. OCT depth capture can range from a single B-scan (2D cross-section) to large-scale volumetric scans spanning cubic millimeters.

### Method 2: Photobleaching all Rounds Post-Embedding in Paraffin Blocks

To prepare for photobleaching, the block is faced on the microtome to expose the tissue surface, avoiding moisture or chilling. Leveling is not required at this stage since no pattern has been photobleached yet. However, the microtome mount orientation must be preserved in later rounds to minimize sectioning tilt. The exposed block is then transferred to the OCT-photobleaching setup, where a coverslip is placed over the tissue and the OCT objective is immersed in water. The sample is leveled to align the tissue with the focal plane. Using the same cassette anchoring and setup, block orientation is maintained across all rounds of photobleaching.

### Method 3: Pattern Placement Variations

In both methods, we tested multiple barcode pattern placements across rounds. Patterns can be positioned anywhere within the imaging region, as long as successive rounds avoid reusing the same (x, y) coordinates. Layouts are alternated to prevent overlap. OCT imaging can align with or between photobleached regions. Placement coordinates are chosen based on tissue shape, imaging field of view, and region of interest. This flexible patterning supports adaptation to various tissue morphologies, biological structures, and instrument precision, making the protocol broadly applicable.

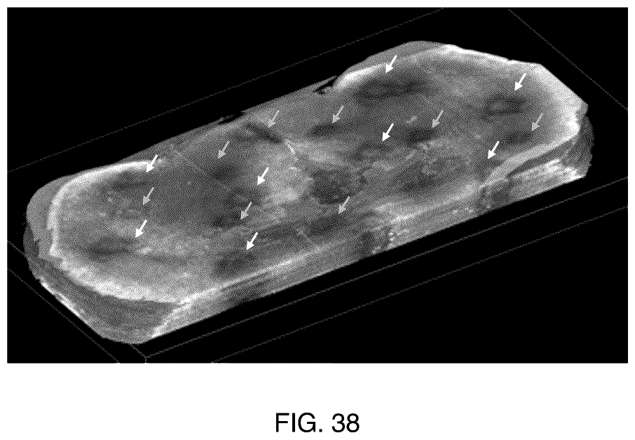

FIG. 38 shows an example of variation in pattern placement across rounds. Aligned and stacked histological sections reveal a pattern layout distinct from the default protocol, illustrating a variation in spatial barcode placement. The histology section at the top of this aligned stack contains two rounds of photobleach patterns: Round 1 barcodes (grey arrows) and Round 2 barcodes (white arrows).

F) 3D Rendering from 2D Images

The preceding examples generally relate to alignment of 2D histology images to a 3D OCT image of a sample using a 3D pattern formed in the sample. From such work, it is also possible to omit the initial 3D OCT image of the sample, and instead use the 3D pattern formed in the sample to assist with rendering a 3D histology image using the 2D histology images.

1. A method of aligning a 2D image to a corresponding 3D image, the method comprising:
providing a 3D sample;
writing a predetermined pattern within the 3D sample;
cutting a 2D slice from the 3D sample after the predetermined pattern is present;
imaging the 3D sample to provide a 3D image with a first imaging modality;
imaging the 2D slice to provide a 2D image with a second imaging modality, wherein the predetermined pattern provides reference features in the 2D image; and
automatically determining a 2D section of the 3D image that corresponds to the 2D image using the reference features in the 2D image;
wherein an alignment accuracy of the 2D image to the corresponding 3D image is 10 microns or better.

2. The method of claim 1, wherein the writing a predetermined pattern within the 3D sample comprises optically writing the predetermined pattern via bleaching of fluorescence in an auto-fluorescent sample.

3. The method of claim 1,
wherein the writing a predetermined pattern within the 3D sample comprises performing a sensitization method on the 3D sample to provide a fluorescence-sensitized sample, followed by optically writing the predetermined pattern via bleaching of fluorescence in the fluorescence-sensitized sample;
wherein the sensitization method is selected from the group consisting of: providing a genetic fluorescence marker to a biological sample, encasing the sample in a fluorescent gel, encasing the sample in a fluorescent glue, encasing the sample in a fluorescent paraffin, and staining the sample with a fluorescent stain.

4. The method of claim 1, wherein the writing the predetermined pattern within the 3D sample is performed with a laser beam having a spot size w and a Rayleigh range z_{R}, and wherein z_{R}≤10w.

5. The method of claim 1, wherein the predetermined pattern includes features at two or more distinct depths in the sample.

6. The method of claim 1, wherein the predetermined pattern includes one or more features having two diagonally connected parallel line segments in a top view.

7. The method of claim 1, further comprising improving an alignment accuracy of the 2D image to the corresponding 3D image by recognizing cellular features.

8. The method of claim 1, wherein the 3D sample is in a live animal during the steps of writing the predetermined pattern within the 3D sample and imaging the 3D sample.

9. The method of claim 1, wherein the 3D sample has a sample surface and wherein the 2D slice has an orientation selected from the group consisting of: parallel to the sample surface, perpendicular to the sample surface, and at an angle θ with respect to the sample surface such that 0<θ<90 degrees.

10. The method of claim 1, further comprising accounting for non-planarity of the 2D slice.

11. The method of claim 1, wherein the cutting the 2D slice from the 3D sample is performed by a method selected from the group consisting of: cryosectioning and paraffin block sectioning.

13. The method of claim 1, further comprising locating a sample surface of the 3D sample to enable depth-selective bleaching at a depth range from 0 to 500 microns below the sample surface.

14. The method of claim 1, further comprising placing the 3D sample in a sample holder having a transparent top window, whereby a sample surface of the sample is flattened.

15. The method of claim 1, further comprising one or more repetitions of the steps of:
writing a predetermined pattern within the 3D sample;
cutting a 2D slice from the 3D sample after the predetermined pattern is present;
imaging the 2D slice to provide a 2D image with a second imaging modality, wherein the predetermined pattern provides reference features in the 2D image;
whereby multiple 2D images are provided having consistent alignment features from a single predetermined pattern.

16. A method of rendering a 3D image from 2D images, the method comprising:
providing a 3D sample;
writing a predetermined pattern within the 3D sample;
cutting two or more 2D slices from the 3D sample after the predetermined pattern is present;
imaging the two or more 2D slices to provide two or more 2D images with one or more imaging modalities, wherein the predetermined pattern provides reference features in the two or more 2D images that are related to the predetermined pattern; and
rendering a 3D image using the two or more 2D images, facilitated by the reference features in the two or more 2D images.
